(19) United States
(12) Patent Application Publication
(10) Pub. No.: US 2026/0316035 A1
(43) Pub. Date: Oct. 15, 2026

(54) SYSTEMS AND METHODS FOR CONTINUOUS REACTORS

(71) Applicant: Found Energy Co, Boston, MA (US)

(72) Inventors: Nicholas Craig, Woburn, MA (US); Peter Godart, Cambridge, MA (US); Luis Franco Carbajal, Cambridge, MA (US); Ariel Jackson, Medford, MA (US)

(21) Appl. No.: 19/485,747

(22) PCT Filed: May 17, 2024
(86) PCT No.: PCT/US2024/029932

§ 371 Date: Nov. 19, 2025

Related U.S. Application Data
(60) Provisional application No. 63/503,439, filed on May 19, 2023.
(60) Provisional application No. 63/644,813, filed on May 9, 2024.

(51) Int. Cl. B01J 19/00; B01J 3/02; B01J 3/03

(52) U.S. Cl. CPC B01J 19/0006; B01J 3/02; B01J 3/03; B01J 19/0073

(57) ABSTRACT

Embodiments described herein relate to continuous aluminum-water reactor systems, methods, and associated devices for reacting aluminum fuel with water to produce thermal energy. In some embodiments, a reactor vessel includes at least one filter with different mesh size openings to separate the aluminum fuel based on particle size. In some embodiments, a reactor vessel includes at least one inlet and spray nozzle to exfoliate aluminum fuel briquettes, decreasing particle sizes for increased surface area and reactivity. In some embodiments the continuous aluminum-water reactor system is configured to continuously add fuel and remove byproducts from the reactor vessel.

### CROSS REFERENCE TO RELATED APPLICATIONS

This application claims the benefit of and priority to U.S. Provisional Patent Application No. 63/503,439, filed on May 19, 2023; and U.S. Provisional Patent Application No. 63/644,813, filed on May 9, 2024, the disclosure of each of which is hereby incorporated by reference in its entirety for all purposes

### TECHNICAL FIELD

The present disclosure relates to devices, systems, and methods for continuous aluminum-water reaction. Specifically, the disclosure is related to the configurations of aluminum-water reactors and associated subsystem components.

### BACKGROUND

Aluminum is a promising candidate for energy storage due to its high energy density, abundance, low cost, non-toxicity, non-volatility, and non-reactivity in storage. One method of extracting the energy from aluminum is to react the aluminum with water to form hydrogen and heat as described in Reaction 1 or Reaction 2.

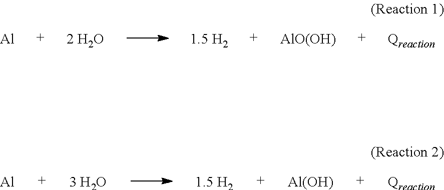

### BRIEF SUMMARY

In one aspect, embodiments described herein relate to a continuous aluminum-water reactor system. In one aspect, a continuous aluminum-water reactor system includes a reactor vessel includes a first vessel end, a second vessel end, a vessel wall defining an interior cavity between the first vessel end and the second vessel end, and a first filter having a first mesh size and disposed within the interior cavity and configured to at least partially retain a first portion of a first plurality of fuel particles having a first average size, a first maximum size or first range of sizes; a first spray nozzle configured to spray a fluid on the first plurality of fuel particles to breakdown, agitate, and/or react the fuel particles to transform the first plurality of fuel particles to byproducts capable of passing through the first filter. The continuous aluminum-water reactor system also includes a first outlet at least partially disposed through the second vessel end of the reactor vessel and configured to allow one or more byproducts capable of passing through the first filter to exit the reactor vessel. In some embodiments, the continuous aluminum-water reactor system may also include where the byproducts comprise reacted aluminum, aluminum oxide, aluminum hydroxide, aluminum oxyhydroxide, or a combination of two or more thereof. The continuous aluminum-water reactor system may also include where the first spray nozzle is coupled with an inlet pipe passing through the vessel wall so as to provide the fluid to the first spray nozzle. The continuous aluminum-water reactor system may also include where the first outlet is configured to exit byproducts, liquid, gas, steam, or a combination of two or more thereof. The continuous aluminum-water reactor system may also include a second filter having a second mesh size and configured to retain a second portion of the plurality of fuel particles having a second average size, a second maximum size, or second range of sizes smaller than the first average size, first maximum size, or first range of sizes, respectively, of the first plurality of fuel particles, and a third filter having a third mesh size and configured to retain a third portion of the plurality of fuel particles, where the third mesh size is finer than both the second mesh size and the first mesh size, and where the second mesh size is finer than the first mesh size. The continuous aluminum-water reactor system may also include at least one of a continuously stirred reaction vessel and a catalyst recovery vessel. The continuous aluminum-water reactor system may also include a second outlet at least partially disposed through the vessel wall, where the first outlet is coupled with a first control valve and a second outlet is coupled to a second control valve, and where at least one of the first control valve and the second control valve is configured to transition between an open configuration which is configured to exit an outlet stream and a closed configuration which is configured to block fluid communication through the valve. The continuous aluminum-water reactor system may also include a second spray nozzle at least partially disposed in the interior cavity and a fuel inlet configured to at least partially pass through the vessel wall, thereby forming an opening through which to enter the first plurality of fuel particles. The continuous aluminum-water reactor system may also include where at least one of the first spray nozzle, the second spray nozzle, the third spray nozzle, and the fourth spray nozzle is configured to emit a spray plume at an angle between 45-60 degrees, 60-90 degrees, or 90-102 degrees relative to a longitudinal axis of the interior cavity. The continuous aluminum-water reactor system may also include a second spray nozzle at least partially disposed through the vessel wall at a position closer to the second vessel end than the first spray nozzle. The continuous aluminum-water reactor system may also include where the reactor vessel is configured to operate at a pressure greater than 5 psig and a temperature greater than 80° C. The continuous aluminum-water reactor system may also include where the one or more byproducts includes a plurality of exfoliated fuel particles having a particle size of less than 1000 micrometers. The continuous aluminum-water reactor system includes a first inlet configured to provide the plurality of fuel particles having an initial average size, an initial maximum size, or an initial range of sizes to the interior cavity from a fuel loading apparatus. The continuous aluminum-water reactor system may also include a second outlet includes steam and/or hydrogen. The continuous aluminum-water reactor system may also include a sensor configured to test a concentration of the at least one byproduct at a location below the one or more filters. The continuous aluminum-water reactor system may also include where the reactor vessel includes less than 4% air and/or less than 4% oxygen. The continuous aluminum-water reactor system may also include a first flow valve coupled to the first inlet and configured to control flow. The continuous aluminum-water reactor system may also include a second reactor vessel includes a second reactor filter retaining a second plurality of aluminum fuel particles, a reactor inlet configured to provide water to the reactor vessel and the second reactor vessel, thereby coupling the reactor vessel and the second reactor vessel in parallel, a secondary vessel, and a reactor outlet configured to transport byproducts from the first and second reactor vessels to the secondary vessel. In some embodiments, the continuous aluminum-water reactor system may also include a fourth filter having a fourth mesh size and configured to retain a fourth portion of the plurality of fuel particles, where the fourth mesh size is finer than each of the first mesh size, the second mesh size, and the third mesh size. The continuous aluminum-water reactor system may also include where at least one of the first filter, the second filter, the third filter, and the fourth filter is configured to separate at least one reaction byproduct from the plurality of fuel particles. The continuous aluminum-water reactor system may also include where at least one of a first outlet and the second outlet feed into the at least one of the continuously stirred reaction vessel and the catalyst recovery vessel. The continuous aluminum-water reactor system may also include where the secondary vessel is the continuously stirred reaction vessel having an agitator and configured to react a plurality of reactive byproducts from the first outlet and the second outlet completely. The continuous aluminum-water reactor system may also include where the first outlet is configured to release at least one of hydrogen and steam from the reactor vessel. The continuous aluminum-water reactor system may also include where water is added to the continuously stirred reaction vessel to support at least one of catalyst recovery, byproduct removal, separation of solid materials, or any combination thereof. The continuous aluminum-water reactor system may also include where the second spray nozzle is located at a position between a first end of a mesh basket and a second end of the mesh basket within the reactor vessel. The continuous aluminum-water reactor system may also include a third spray nozzle at least partially disposed in the interior cavity. The continuous aluminum-water reactor system may also include where the third spray nozzle is located distal to the first spray nozzle, the second spray nozzle, and/or the first filter distal end. The continuous aluminum-water reactor system may also include a fourth spray nozzle at least partially disposed in the interior cavity. The continuous aluminum-water reactor system may also include where the fourth spray nozzle is located distal to the distal end of the filter closest to the outlet in the reactor vessel. The continuous aluminum-water reactor system may also include where the spray plume has a substantially cone-like shape. The continuous aluminum-water reactor system may also include where at least one of the first spray nozzle and the second spray nozzle is configured to add water to the reactor vessel to control a water level within the interior cavity of the reactor vessel. The continuous aluminum-water reactor system may also include a third spray nozzle at least partially disposed through the vessel wall where the third spray nozzle is oriented in a direction parallel to an inner surface of the vessel wall. The continuous aluminum-water reactor system may also include where the third spray nozzle is configured to emit one or more fluids in a direction and orientation such that the one or more fluids contact at least a portion of the inner surface of the vessel wall to wash and remove debris from the inner surface of the vessel wall. The continuous aluminum-water reactor system may also include where the third spray nozzle is configured to emit the one or more fluids in a direction and orientation such that the one or more fluids avoid contact with the fuel retained by a central portion of the first filter. The continuous aluminum-water reactor system may also include where the one or more fluids includes water. The continuous aluminum-water reactor system may also include where the continuous aluminum-water reactor system is configured to produce at least one megawatt of thermal energy. The continuous aluminum-water reactor system may also include a second flow valve coupled to the outlet and configured to control flow. The continuous aluminum-water reactor system may also include a water recirculation line configured to exit the continuously stirred reaction vessel, catalyst recovery vessel, and/or fluid storage vessel to feed into the reactor inlet. The continuous aluminum-water reactor system may also include where the secondary vessel is at least one of a continuously stirred reaction vessel and a catalyst recovery vessel. The continuous aluminum-water reactor system may also include where the at least one of the continuously stirred reaction vessel and the catalyst recovery vessel further includes an agitator and configured to mix water with at least one reactor outlet byproduct until said at least one reactor byproduct has fully reacted. The continuous aluminum-water reactor system may also include where the at least one of the continuously stirred reaction vessel and the catalyst recovery vessel further includes at least one of a light outlet stream includes hydrogen and steam, and a heavy outlet stream includes water, an inert sludge, and/or a slurry. The continuous aluminum-water reactor system may also include where the light outlet stream feeds into a light stream vessel and the heavy outlet stream feeds into a heavy stream vessel. The continuous aluminum-water reactor system may also include where the light outlet stream is configured to feed into a compressor configured to increase a steam pressure, a hydrogen gas pressure, or a combination of a steam pressure and a hydrogen gas pressure to a desired outlet pressure.

Embodiments described herein further describe a method for a continuous aluminum-water reaction in a reactor vessel including a first filter having a first mesh size disposed within a reactor vessel interior cavity configured to at least partially retain a first portion of a plurality of fuel particles having a first particles size or range of sizes, the method includes spraying the first portion of the plurality of fuel particles with a fluid from an nozzle to breakdown, agitate, and/or react the fuel particles to transform the first portion of the plurality of fuel particles to byproducts capable of passing through the first filter, and exiting one or more byproducts capable of passing through the first filter with the plurality of fuel particles to exit the reactor vessel though a first outlet, where the byproducts comprise at least one of activated aluminum and reacted aluminum. In some embodiments, the method may also include where the byproducts comprise reacted aluminum, aluminum oxide, aluminum hydroxide, aluminum oxyhydroxide, or a combination of two or more thereof. The method may also include where the fluid includes water. The method may also include where the fluid consists essentially of water. The method may also include replenishing a second portion of the plurality of fuel particles having a first average size, a first maximum size or a first range of sizes into the first filter of the reactor vessel. The method may also include where replenishing the second portion of the plurality of fuel particles is continuous based on a prescribed rate of inputs, based on the concentration or composition of the byproducts, or based on a prescribed time duration. The method may also include measuring a concentration of the one or more byproducts in the first outlet. The method may also include disposing the one or more byproducts into a secondary vessel. The method may also include mixing the one or more byproducts with water. The method may also include measuring the operating pressure within reactor vessel with a sensor, relaying the operating pressure from the sensor to a processor, comparing the operating pressure with a threshold pressure with the processor, and where if the operating pressure is below the threshold pressure, replenishing the plurality of fuel particles into the reactor. The method may also include measuring the operating temperature within reactor vessel with a sensor, relaying the operating temperature within the reactor from the sensor to a processor, comparing the operating temperature with a threshold temperature with the processor, and where if the operating temperature is below the threshold temperature, replenishing the plurality of fuel particles into the reactor. The method may also include washing an inner surface of the reactor vessel interior cavity with a fluid emitted from a spray nozzle to remove debris. The method may also include replenishing the plurality of fuel particles having the first average size, the first maximum size or the first range of sizes into the first filter of the reactor vessel. The method may also include where replenishing the plurality of fuel particles occurs when the concentration of a non-fluid portion of the byproducts is greater than zero. The method may also include where replenishing the plurality of fuel particles occurs when the concentration of a non-fluid portion of the byproducts is greater than 5% (w/v). The method may also include where replenishing the plurality of fuel particles occurs when the concentration of a non-fluid portion of the byproducts is greater than 10% (w/v). In some embodiments, the method for a continuous aluminum-water reaction includes setting up a continuous aluminum-water reactor system introducing the plurality of fuel particles of the first average size, the first maximum size or the first range of sizes into the first filter of the reactor vessel, replenishing the plurality of fuel particles of the first average size, the first maximum size or the first range of sizes into the first filter of the reactor vessel, spraying the plurality of fuel particles introduced or replenished with a fluid, and allowing one or more byproducts of the reaction of water with the plurality of fuel particles to exit the reactor vessel though the first outlet, where the byproducts comprise at least one of inert aluminum and activated aluminum, where replenishing the plurality of fuel particles is based on a prescribed rate of inputs, based on a concentration or a composition of the byproducts, an operating pressure within the reactor, a temperature within the reactor, or based on a prescribed time duration. In some embodiments, the method may also include measuring the operating temperature within reactor vessel with a sensor, relaying the operating temperature within the reactor from the sensor to a processor, comparing the operating temperature with a threshold temperature with the processor, and where if the operating temperature is below the threshold temperature, replenishing the plurality of fuel particles into the reactor. The method may also include washing an inner surface of the reactor vessel interior cavity with a fluid emitted from a spray nozzle to remove debris. The method may also include replenishing the plurality of fuel particles having the first average size, the first maximum size or the first range of sizes into the first filter of the reactor vessel. The method may also include where replenishing the plurality of fuel particles occurs when the concentration of a non-fluid portion of the byproducts is greater than zero. The method may also include where replenishing the plurality of fuel particles occurs when the concentration of a non-fluid portion of the byproducts is greater than 5% (w/v). The method may also include where replenishing the plurality of fuel particles occurs when the concentration of a non-fluid portion of the byproducts is greater than 10% (w/v). The method may also include measuring a concentration of the one or more byproducts in the first outlet. The method may also include disposing the one or more byproducts into a secondary vessel. The method may also include mixing the one or more byproducts with water. The method may also include where replenishing the plurality of fuel particles occurs when the prescribed time duration is greater than one minute. The method may also include where replenishing the plurality of fuel particles occurs when the prescribed time duration is greater than five minutes. The method may also include where replenishing the plurality of fuel particles occurs when the prescribed time duration is greater than one hour. The method may also include where replenishing the plurality of fuel particles occurs when the prescribed time duration is greater than 24 hours. The method may also include where spraying the plurality of fuel particles comprises emitting a spray plume the fluid from a first spray nozzle, a second spray nozzle, a third spray nozzle, a fourth nozzle, and/or any combination of two or more thereof. The method may also include where at least one of the first spray nozzle, the second spray nozzle, the third spray nozzle, and the fourth spray nozzle is configured to emit a spray plume at an angle between 45-60 degrees, 60-90 degrees, or 90-102 degrees relative to a longitudinal axis of the reactor vessel. Other technical features may be readily apparent to one skilled in the art from the following figures, descriptions, and claims. In some embodiments, the method may also include washing an inner surface of the reactor vessel interior cavity with water emitted from a spray nozzle to remove debris. The method may also include where the secondary vessel is at least one of a continuously stirred reaction vessel and a catalyst recovery vessel. The method may also include reacting the one or more byproducts to completion in the secondary vessel. The method may also include where the secondary vessel is at least one of a continuously stirred reaction vessel and a catalyst recovery vessel. The method may also include reacting the one or more byproducts to completion in the secondary vessel. The method may also include where the spray plume has a substantially cone-like shape. Other technical features may be readily apparent to one skilled in the art from the following figures, descriptions, and claims.

### BRIEF DESCRIPTION OF THE DRAWINGS

Figures illustrated herein are exemplary block drawings showing relative positions of certain elements described herein. However, the figures do not show the exact couplings or connections that may or may not exist between elements. Additionally, in some drawings, internal and external features may be shown in the same renderings for conceptualizing the overall concepts and not for conceptualizing them from an engineering perspective.

FIG. 1 illustrates a continuous aluminum-water reactor system and configuration of a reaction vessel, according to embodiments described herein.

FIG. 2 illustrates a diagram of a continuous aluminum-water reactor system having a reaction vessel and a secondary vessel, according to embodiments described herein.

FIG. 3 illustrates a continuous aluminum-water reactor system and configuration of a reaction vessel, according to embodiments described herein.

FIG. 4 illustrates a diagram of a continuous aluminum-water reactor system having a reaction vessel, and a second reaction vessel, a secondary vessel arranged in parallel, according to embodiments described herein.

FIG. 5 illustrates an example of a continuous aluminum-water reactor system having a reactor retaining a first spray nozzle and a second spray nozzle, according to embodiments described herein.

FIG. 6 illustrates an example of a continuous aluminum-water reactor system having a reactor retaining a first spray nozzle a second spray nozzle, a third spray nozzle, and a fourth spray nozzle, according to embodiments described herein.

### DETAILED DESCRIPTION

The reaction between aluminum and water is a highly exothermic process resulting in heat which can be used to produce energy. Provided herein are systems, methods, and devices for reacting water with aluminum and removing a protective oxidative layer through chemical or mechanical means. Systems, methods, and devices of the present disclosure create a high throughput process for an efficient and controlled reaction.

Current approaches to aluminum-water reactor system includes using a batch process and associated system to react water with aluminum. Water is added to the reaction in pulses or through a single large addition. The reaction byproducts and any water that has not reacted with the aluminum or vaporized is collected in a reactor vessel. Once the fuel is consumed, the reactor vessel or container is shut down and emptied to add more reactants. Shutting down the reactor may be costly and time consuming.

Further, the reactor vessel size needed to support megawatt (MW) or gigawatt (GW) scale energy production in a batch process is expensive and includes safety concerns due to the large volume/mass of fuel needed to operate for more than a few hours. Also, in a batch process, as byproduct accumulates and fuel is consumed, the concentration of active fuel relative to byproduct decreases over time eventually resulting in a ‘cooldown’ period where the power output required is no longer sufficient and the remaining fuel is wasted or discarded.

Provided herein are systems, methods, and devices to support industrial processes and large-scale energy and hydrogen demands while operating safely, continuous aluminum-water reaction systems with continuous additions of fuel are needed to continuously operate the aluminum-water reaction alongside existing infrastructure.

These continuous processes and systems that provide a safe, controlled, and efficient reaction between aluminum and water. These improved continuous processes, devices, and systems support continuous addition of fuel, remove the oxide layer, precise addition of water, predictable initiation, and completion of the reaction, run continuously, safety, and cost efficiency.

Certain aspects of embodiments disclosed herein are directed to continuous tube reactors and continuous aluminum-water reactor systems for the continuous addition of fuel to an aluminum-water reactor. In some embodiments, continuous aluminum-water reactor systems support continuous fuel addition, continuous removal of byproduct, and continuous power output.

The reactor vessels or plurality of reactor vessels described herein support the addition of aluminum fuel having relatively larger (greater than 1 cm in diameter) particle sizes. Systems, methods, and devices provided herein reduce or eliminate the need to pre-shred or pulverize the active fuel to increase surface area which takes considerable energy. High surface area in fuel is important for aluminum-water reactions because as the available surface area for aluminum and water to react increases, the efficiency of the reaction and therefore maximum power output also increases.

Systems, methods, and devices of the present disclosure feed large solids such as aluminum briquettes continuously to reactors operating at high temperature and pressure. Systems, methods, and devices of the present disclosure exfoliate larger aluminum fuel particles, such as aluminum briquettes, within the reactor to increase surface area for the reaction to occur.

Due to the unique configuration of systems described herein, larger particles of fuel are broken down or exfoliated within the reactor, reducing additional energy needed to break down the fuel. Larger sized aluminum fuel is also safer to store and handle because it is relatively inert having relatively low surface area until the aluminum fuel enters the reactor and is broken down. The continuous aluminum-water reactor system also provides systems and methods to convert reactive byproducts produced by the vessel reactor into relatively inert, reacted byproducts such as aluminum oxyhydroxide thereby reducing safety risks. In some embodiments, the byproducts comprise reacted aluminum, aluminum, oxide, aluminum hydroxide, aluminum oxyhydroxide, or a combination of two or more thereof.

The continuous aluminum-water reactor processes and systems described herein are configured to exfoliate aluminum fuel to remove the protective oxidative layer in controlled conditions with no oxygen or negligible amounts of oxygen. Removal of oxygen from the reactor vessels performing aluminum-water reactions may reduce safety risks such as explosive hazards and catalyst breakdown. In some embodiments, a reactor vessel comprises less than 4% air. In some embodiments, a reactor vessel comprises less than 4% oxygen. In some embodiments, a reactor vessel comprises less than 4% air. In some embodiments, a reactor vessel comprises less air and/or oxygen than the lower explosive limit for a reaction occurring within the reaction vessel.

Furthermore, the described reactor vessel includes multiple layers of filtration/mesh/screens to support and separate the large solids, exfoliated reactive products, byproduct, and recycled plastics within the reactor itself rather than in a downstream process. In some embodiments, each stream is configured to be isolated and processed individually.

As used herein the term “particle diameter,” “fuel diameter,” or “particle size” refers to a particle or range or particles characterized by an equivalent spherical sieve diameter.

As used herein, the term “filter” refers to any mesh, screen, non-woven fibrous material, or any other material used to separate particles by size or chemical group.

As used herein, the term “exfoliate” refers to reduction in particle size due to the continuous removal of one or more surface layers and/or disintegration of the particle along grain boundaries thereby exposing additional and/or different surface areas of the particle that are without oxide coverage to the fuel. For example, when an aluminum fuel particle is exfoliated at least a portion of a surface layer is removed from the aluminum fuel surface to expose a fresh surface of the fuel with no oxide coverage. Further, successive layers of the surface of the aluminum particle may be removed from the aluminum particle through exfoliation. Also, the aluminum particle may disintegrate along grain boundaries through exfoliation.

As used herein the terms “pellets” and “particles” are used interchangeably herein with pucks, briquettes, and large particles. For example, large particles as described herein may include particles having an equivalent spherical sieve diameter larger than five millimeters. For example, the larger particles of aluminum-based fuel fed into reactors as described herein are larger than the feed fuel used in traditional aluminum-water reactors.

As used herein, the term “nozzle” refers to a single nozzle, a group of nozzles, or an array of nozzles.

As used herein, the term “about” means within +10% of the value it modifies. For example, “about 1” means “0.9 to 1.1”, “about 2%” means “1.8% to 2.2% ”, “about 2% to 3%” means “1.8% to 3.3%”, and “about 3% to about 4%” means “2.7% to 4.4%.” Unless otherwise clear from the context, all numerical values provided herein are modified by the term “about”.

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements).

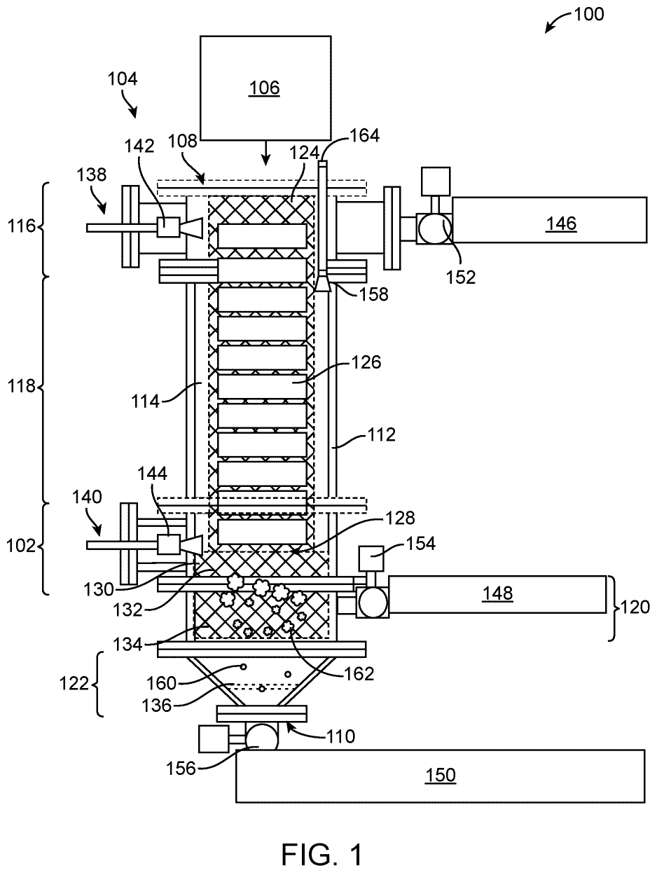

FIG. 1 illustrates an embodiment of a continuous aluminum-water reactor system 100 having a reactor vessel 104, fuel loading apparatus 106, and a plurality of inlet and outlet streams. In some embodiments, the reactor vessel 104 has a first vessel end 108, a second vessel end 110, and a vessel wall 112 therebetween. In some embodiments, the reactor vessel 104 is hollow and has a longitudinal interior cavity 114 extending from the first vessel end 108 to the second vessel end 110.

In some embodiments, the reactor vessel 104 has at least one of a first vessel region 116, second vessel region 118, third vessel region 102, fourth vessel region 120, and fifth vessel region 122. In some embodiments, the reactor vessel 104 has a first vessel region 116, a second vessel region 118, a third vessel region 102, a fourth vessel region 120, and a fifth vessel region 122. In some embodiments, the first vessel region 116 is coupled to the second vessel region 118 which is coupled to third vessel region 102 which is coupled to fourth vessel region 120 which is coupled to fifth vessel region 122. In some embodiments, the fifth vessel region 122 is at the bottom of the reactor vessel 104. In some embodiments, the fifth vessel region 122 has a generally conical shape. In some embodiments, the fifth vessel region 122 has a generally truncated conical shape. In some embodiments, at least one of the first vessel region 116, second vessel region 118, third vessel region 102, fourth vessel region 120, and fifth vessel region 122 has a generally cylindrical shape. In some embodiments, the reactor vessel is a tube reactor. In some embodiments, the reactor vessel 104 is a standard flanged pipe. In some embodiments, the reactor vessel 104 has a shape configured to facilitate the reaction of water with aluminum. In some embodiments, a plurality of reactor vessels 104 are configured in parallel. For example, more than two reactor vessels 104 may be configured together within the continuous aluminum-water reactor system 100 to scale the output/throughput capacity of the continuous aluminum-water reactor system 100.

In some embodiments, the reactor vessel 104 is configured to operate at a pressure greater than 5 psig. In some embodiments, the reactor vessel 104 is configured to operate at a pressure between 5-15 psig. In some embodiments, the reactor vessel 104 is configured to operate at a pressure between 5-10 or 10-15 psig. In some embodiments, the reactor vessel 104 is configured to operate at a pressure between 0-200 bar. In some embodiments, the reactor vessel 104 is configured to operate at a pressure between 0-50, 50-100, 100-150, or 150-200 bar. In some embodiments, the reactor vessel is configured to operate at temperature greater than 80° C. In some embodiments, the reactor vessel is configured to operate at temperature between 80-105° C. In some embodiments, the reactor vessel is configured to operate at temperature between 80-365° C. In some embodiments, the reactor vessel is configured to operate at temperature between 80-85, 85-90, 90-95, 95-100, or 100-105° C. In some embodiments, the reactor vessel is configured to operate at temperature between 80-85, 85-90, 90-95, 95-100, or 100-105, 105-110, 110-115, 115-120, 120-125, 125-130, 130-135, 135-140, 140-145, 145-150, 150-155, 155-160, 160-165, 165-170, 170-175, 175-180, 180-185, 185-190, 190-195, 195-200, 200-205, 205-210, 210-215, 215-220, 220-225, 225-230, 230-235, 235-240, 240-245, 245-250, 250-255, 255-260, 260-265, 265-270, 270-275, 275-280, 280-285, 285-290, 290-295, 295-300, 300-305, 305-310, 310-315, 315-320, 320-325, 325-330, 330-335, 335-340, 340-345, 345-350, 350-355, 355-360, or 360-365° C.

In some embodiments, fuel is added from the fuel loading apparatus 106 to the reactor vessel 104 at the first vessel end 108. In some embodiments, the reactor vessel 104 is configured to include a fuel port (not shown) for continuously adding fuel into the reactor vessel 104. In some embodiments, replenishing the plurality of fuel particles occurs when a prescribed time duration is greater than one minute. In some embodiments, replenishing the plurality of fuel particles occurs when a prescribed time duration is greater than five minutes. In some embodiments, replenishing the plurality of fuel particles occurs when a prescribed time duration is greater than one hour. In some embodiments, replenishing the plurality of fuel particles occurs when a prescribed time duration is greater than 24 hours. In some embodiments, replenishing the plurality of fuel particles occurs when a concentration of a non-fluid portion of the byproducts is greater than zero. In some embodiments, replenishing the plurality of fuel particles occurs when a concentration of a non-fluid portion of the byproducts is greater than 5% weight per volume (w/v). In some embodiments, replenishing the plurality of fuel particles occurs when a concentration of a non-fluid portion of the byproducts is greater than 10% (w/v). In some embodiments, replenishing the plurality of fuel particles occurs when a concentration of a non-fluid portion of the byproducts is greater than any one of 0% (w/v), 5% (w/v), 10% (w/v), 15% (w/v), 20% (w/v), 25% (w/v), 30% (w/v), 35% (w/v), 45% (w/v), 50% (w/v). In some embodiments, replenishing the plurality of fuel particles occurs when a prescribed time duration is greater than any one of 0 minutes, 2 minutes, 10 minutes, 15 minutes, 20 minutes, 25 minutes, 30 minutes, 1 hour, 2 hours, 3 hours, 4 hours, 5 hours, 1 day, 2 days, 3 days, 1 week, 2 weeks, 3 weeks, 1 month, 2 months, 3 months, 1 year.

In some embodiments, the fuel loading apparatus 106 is configured to deposit fuel into the reactor vessel 104 while the continuous aluminum-water reactor system 100 is operating under non-atmospheric conditions. In some embodiments, the continuous aluminum-water reactor system 100 non-atmospheric conditions are at elevated pressures, elevated temperatures, with low concentration of oxygen, and any combination thereof. In some embodiments, the fuel loading apparatus 106 is operated discretely and/or semi-continuously during the operation of the continuous aluminum-water reactor system 100. In some embodiments, the fuel loading apparatus 106 is operated continuously during the operation of the continuous aluminum-water reactor system 100. In some embodiments, the fuel is added to the continuous aluminum-water reactor system 100 by the fuel loading apparatus 106 in any variable increment of mass or volume. In some embodiments, the frequency of loading fuel is prescribed on a time basis. In some embodiments, the frequency of loading fuel is according to a control strategy based on an operating condition of the continuous aluminum-water reactor system 100. In some embodiments, the control strategy maintains a certain pressure in any portion of the continuous aluminum-water reactor system 100 or subsystem given an out-flow condition of the continuous aluminum-water reactor system 100. In some embodiments, the control strategy maintains outlet volumetric or mass flow rates of the continuous aluminum-water reactor system 100 or any subsystem given any pressure conditions of the continuous aluminum-water reactor system 100.

In some embodiments, a plurality of fuel particles is added to the reactor vessel 104 without oxidizing or reducing pressure within the interior cavity 114 of the reactor vessel 104. In some embodiments, the plurality of fuel particles comprises aluminum. In some embodiments, the fuel comprises activated aluminum fuel. In some embodiments, the fuel is added to the reactor vessel 104 continuously. In some embodiments, fuel is added to the reactor vessel 104 without shutting down the reactor vessel to add the fuel. In some embodiments, fuel is added to the reactor vessel 104 as larger particles. In some embodiments, the reactor vessel is configured to exfoliate particles of fuel to reduce the size of the particles of fuel within the interior cavity 114 of the reactor vessel. In some embodiments, the plurality of fuel particles initially added into the reactor vessel are larger than one inch in at least one dimension. In some embodiments, the plurality of fuel particles added initially into the reactor vessel 104 have at least one dimension or a range of dimensions exceeding five millimeters. In some embodiments, the plurality of fuel particles added initially into the reactor vessel have at least one dimension or a range of dimensions exceeding one centimeter. In some embodiments, at least a portion of the particles of fuel leaving the reactor have at least one dimension or a range of dimensions in the micrometer or nanometer size range. In some embodiments, one or more byproducts comprises a plurality of exfoliated fuel particles having at least one dimension or range of dimensions less than 1000 micrometers.

In some embodiments, at least one filter comprises mesh configured to completely cover the internal diameter or cross-section of the interior cavity 114. In some embodiments, the at least one filter has at least one opening configured to prevent clogging. In other embodiments at least one filter comprises a mesh or screen configured to filter particles and having a basket-type configuration wherein the mesh or screen forms a basket or container configuration that does not cover the entire cross-sectional area of the interior cavity 114. In some embodiments, the basket configuration is configured to permit exfoliated fuel particles to flow over the sides if the basket clogs. In some embodiments, the openings in at least one filter configured to cover the entire cross section of the interior cavity 114 are larger than the openings in the basket configuration.

In some embodiments, the first filter 124 of the reactor vessel 104 has one or more trays 126 configured to hold pellets of fuel and located between the first vessel end 108 and the first filter bottom surface 128. In some embodiments, fuel is added to the reactor vessel 104 as large particles (having at least one dimension greater than one centimeter), aluminum pucks, trays of pellets, briquettes, or any combination thereof.

In some embodiments, a portion of the plurality of fuel particles initially added to the reactor vessel 104 from the fuel loading apparatus 106 is retained on a filter platform or bed within the reactor vessel 104 configured to prevent the fuel from falling to the bottom of the reactor vessel 104. In some embodiments, the particles of fuel initially added to the reactor vessel from the fuel loading apparatus 106 is retained within the interior cavity 114 by a first filter bottom surface 128 of a first filter 124. In some embodiments, the first filter bottom surface 128 comprises a screen disposed at least partially transverse to the longitudinal axis of the reactor vessel 104. In some embodiments, the first filter bottom surface 128 is configured to hold a first plurality of particles having a particle size larger than a size of mesh opening for the first filter bottom surface 128 size. In some embodiments, the first filter 124 is located in the first vessel region 116, the second vessel region 118, the third vessel region 102, or any combination thereof.

In some embodiments, the first filter bottom surface 128 has a standard mesh size larger than 7×7 US Standard Mesh with corresponding sized openings. In some embodiments, the first filter bottom surface 128 at least partially includes a 7×7 U.S. Standard Mesh. In some embodiments, the first filter bottom surface 128 has a mesh with one or more openings having at least one dimension exceeding 0.108 inches. In some embodiments, the filter has one or more openings having at least one dimension 0.108 inches or smaller while the plurality of fuel particles entering the reactor vessel 104 has at least one dimension 0.236 inches or larger. In some embodiments, the first filter bottom surface 128 has at least 50% open surface area. In some embodiments, particles having at least one dimension or range of dimensions larger than one or more opening dimension or range of dimensions in the first filter 124 remain within the first filter 124 forming a fuel bed. In some embodiments, particles having at least one dimension or range of dimensions larger than opening size in the first filter 124 remain between first vessel end 108 and the first filter 124 forming a fuel bed.

In some embodiments, a plurality of fuel particles located in the fuel bed between first vessel end 108 and the first filter 124 is exfoliated until the particle size of the fuel is smaller than the opening size of the first filter 124 mesh allowing the plurality of fuel particles to pass through the first filter 124. In some embodiments, a portion of the plurality of fuel particles initially added to the reactor is exfoliated until the particles' size permits the exfoliated fuel to pass through the first filter 124 to support further wetting and exfoliation of the portion of fuel particles within the reactor vessel. In some embodiments, the first filter 124 is configured to retain a portion of a first plurality of particles having at least one dimension smaller than the widest dimension of an opening in a reactor port opening from the fuel loading apparatus 106.

In some embodiments, the reactor vessel 104 comprises a second filter 130. In some embodiments, the second filter 130 has a finer mesh size, featuring smaller openings compared to the first filter 124, which has a larger mesh size and larger openings. In some embodiments, the second filter 132 is located in the third vessel region 102. In some embodiments, the second filter 130 is configured to retain particles having a largest particle dimension or range of dimensions between 1 to 2 millimeters. In some embodiments, the second filter 130 is configured to retain particles having a largest particle dimension or range of dimensions larger than 1 or larger than 2 millimeters. In some embodiments, the second filter 130 has a mesh size with larger openings than the openings in the first filter 124 so as to prevent clogging in the first filter 124. In some embodiments, the second filter 130 is configured to retain a second portion of the first plurality of particles 132 having at least one dimension smaller than the widest dimension of an opening in the first filter 124.

In some embodiments, the reactor vessel 104 comprises a third filter 134. In some embodiments, the third filter 134 has a finer mesh size, featuring smaller openings compared to the first filter 124 and the second filter 130 which have larger mesh size and larger openings. In some embodiments, the third filter 134 is located in the fourth vessel region 120. In some embodiments, reactor vessel comprises a fourth filter 136. In some embodiments, the fourth filter 136 has a finer mesh size, featuring smaller openings compared to the first filter 124 the second filter 130, and the third filter 134 each of which have larger mesh size and larger openings. In some embodiments, the third filter 134 is configured to retain a third portion of a first plurality of particles 132 having at least one dimension smaller than the widest dimension of an opening in the second filter 130.

In some embodiments, the fourth filter 136 is located in the fifth vessel region 122. In some embodiments, particles and/or fluid which pass through the fourth filter 136 comprise reacted fuel byproducts and reactant water and are removed through at least one outlet stream. In some embodiments, the fourth filter 136 is configured to retain a fourth portion of the plurality of particles having at least one dimension smaller than the widest dimension of an opening in the third filter 134. In some embodiments, the fourth filter 136 is configured to prevent or reduce clogging of the exit lines or issues with downstream equipment. In some embodiments, the third filter 134 and the fourth filter 136 are configured to separate unknown solids from contamination in scrap feedstocks. In some embodiments, at least one filter is configured to separate at least one reaction byproduct from activated aluminum. In some embodiments, at least one reaction byproduct is aluminum oxyhydroxide. In some embodiments, the reactor vessel 104 is configured to have a high relative surface area per volume and/or mass of fuel to allow for exfoliation of fuel and bulk transport out of the reactor vessel 104 mesh region once the specified fuel particle size has been attained. For example, the reactor vessel 104 filters may be cylindrical in shape.

In some embodiments, the reactor vessel 104 has at least one inlet pipe. In some embodiments, the reactor vessel 104 has a first inlet pipe 138 and a second inlet pipe 140. In some embodiments, at least one inlet pipe 138, 140 is configured to provide water to the interior cavity 114 of the reactor vessel 104. In some embodiments, at least one pipe is coupled with a spray nozzle. In some embodiments, the first inlet pipe 138 is coupled to a first spray nozzle 142. In some embodiments, the second inlet pipe 140 is coupled to a second spray nozzle 144. In some embodiments, the first inlet pipe 138 and the second inlet pipe 140 are configured to provide water to the reactor vessel 104. In some embodiments, the first inlet pipe 138 and the second inlet pipe 140 are configured to provide water and at least one additive to the reactor vessel, or any combination thereof. In some embodiments, the additive is a chelating compound. In some embodiments, the additive comprises sodium chloride, sodium hydroxide, sodium sulfate, chelating compounds, caffeine.

FIG. 1 illustrates an embodiment of a reactor vessel 104 where the first spray nozzle 142 is located near the top of the reactor vessel 104 and the second spray nozzle 144 is located near the bottom of the reactor vessel. In some embodiments, the first spray nozzle 142 located near the top or first vessel end 108 of the reactor vessel 104 is configured to spray water onto the fuel directly. In some embodiments, the at least one spray nozzle is configured to exfoliate large particles of aluminum-based fuel or large fuel briquettes retained in a tray 126 by spraying water directly on the fuel. In some embodiments, the at least one spray nozzle is configured to spray water to feed the high-power reaction occurring from partially exfoliated fuel particles below the first filter 124. In some embodiments, the partially exfoliated fuel particles have at least one dimension smaller than the widest dimension of the openings in the first filter 124 and larger than the openings in the fourth filter 136 continue to undergo exfoliation while they are retained by the second filter 130, the third filter 134, or the fourth filter 136.

In some embodiments, the second spray nozzle 144 is configured to inject water into the third vessel region 102 to suspend reaction byproducts and/or to react with remaining active fuel particles. In some embodiments, the second spray nozzle 144 remains on to fill the reactor vessel 104 with water. In some embodiments, the second spray nozzle 144 is configured to tunably control a water level within the reactor vessel. In some embodiments, exfoliated fuel remains in the reactor vessel and produces a high-power exothermic reaction from being sprayed with additional water such as from second spray nozzle 144. In some embodiments, the level of water in the reactor vessel is raised or lowered to a water level where the water directly contacts and interacts with fuel particles and briquettes retained by the first filter 124 of the reactor vessel 104. In some embodiments, water is injected into the interior cavity 114 of the reactor vessel 104 to remove solids such as plastics and recycled materials from the continuous aluminum-water reactor system 100.

In some embodiments, the reactor vessel 104 has at least one outlet stream exiting the reactor vessel 104. In some embodiments, the reactor vessel 104 has a first outlet stream 146, and a second outlet stream 148, and a third outlet stream 150. In some embodiments, the first outlet stream 146 is coupled to a first control valve 152, the second outlet stream 148 is coupled to a second control valve 154, and the third outlet stream 150 is coupled to a third control valve 156. In some embodiments, the first outlet stream 146 is configured to feed into a secondary vessel (not shown). In some embodiments, the first outlet stream 146 and/or the second outlet stream 148 comprises at least one of hydrogen, steam, or a combination of hydrogen and steam. In some embodiments, the reactor vessel 104 is oriented vertically with the first outlet stream 146 located above the second outlet stream 148 at a location closer to the first vessel end 108 than the second outlet stream 148 within the reactor vessel 104. In some embodiments, the first outlet stream 146 is located in the first vessel region 116. In some embodiments, the second outlet stream 148 is located in the fourth vessel region 120.

In some embodiments, the first outlet stream 146 and the second outlet stream 148 are configured to feed into a singular secondary vessel. In some embodiments, first outlet stream 146 and the second outlet stream 148 are configured to feed into separate secondary vessels. In some embodiments, at least one secondary vessel is an agitated vessel. In some embodiments, the second outlet stream 148 comprises particles of active fuel. In some embodiments, active fuel in the outlet streams continues and completes reacting in at least one secondary vessel. In some embodiments, the second outlet stream 148, and the third outlet stream 150 comprise one or more byproducts. In some embodiments, the at least one secondary vessel is configured to mix byproducts with additional water for downstream processing. In some embodiments, the at least one secondary vessel is connected to at least one outlet stream and is configured to serve as a location for continued reaction, collection of catalyst, mixture of byproduct, and/or addition of water for downstream processing. In some embodiments, the reactor vessel 104 comprises at least one sensor configured to test at least one byproduct at a location below the one or more filters. In some embodiments, the reactor vessel 104 comprises at least one sensor configured to control a control valve to control the flow fuel particles, water, or a combination of water and fuel particles into and/or out of the reactor vessel 104.

In some embodiments, pressure generated from the reaction, reverse flow from a water injection, or a combination of pressure from the reaction and reverse flow from a water injection drives plastic or other particles through a second outlet stream 148. For example, the plastic or other particles through a second outlet stream 148 may have a density less than the density of the fluid within the reactor thereby making them buoyant within the reactor vessel. In some embodiments, the first outlet stream 146 and the first control valve 152 are located at or adjacent to the top of the reactor vessel configured to permit gaseous products such as steam and hydrogen to exit the reactor vessel through the first outlet stream 146. In some embodiments, the first control valve 152, the second control valve 154, the third control valve 156, or any combination thereof is an automated or manual control valve. In some embodiments, the first control valve 152 is configured to regulate the pressure or flow rate from the reactor vessel such as to support downstream separation and to meet the desired output. In some embodiments, third control valve 156 is configured to regulate the pressure or flow rate for liquids and solids from the reactor vessel to support downstream separation and to meet the desired output. In some embodiments, the third control valve 156 is configured to control the water level in the reactor vessel 104.

In some embodiments, the continuous aluminum-water reactor system 100 comprises a third spray nozzle third spray nozzle 158 at least partially disposed through the vessel wall 112. In some embodiments, the third spray nozzle 158 is oriented in a direction parallel to an inner surface of the vessel wall 112. In some embodiments, the third spray nozzle third spray nozzle 158 is configured to emit one or more fluids in a direction and orientation such that the one or more fluids contact at least a portion of the inner surface of the vessel wall 112 to wash and/or remove debris from the inner surface of the vessel wall 112. In some embodiments, the third spray nozzle 158 is configured to emit the one or more fluids in a direction and orientation such that the one or more fluids avoid contact with the fuel retained by a central portion of the first filter and/or subsequent filters. In some embodiments, the fluid emitted by the third spray nozzle third spray nozzle 158 comprises water.

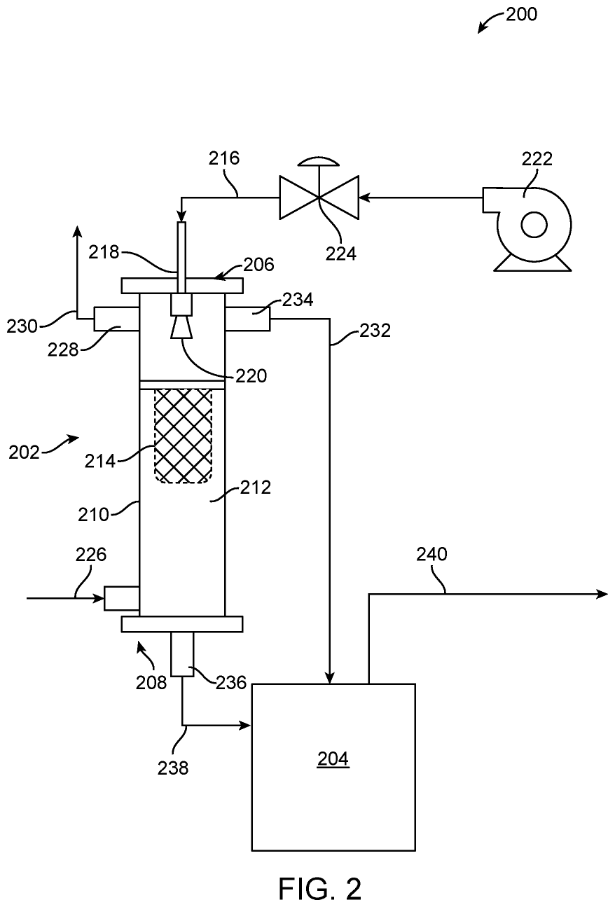

FIG. 2 illustrates a diagram of continuous aluminum-water reactor system 200 including a reactor vessel 202 vessel and a secondary vessel 204, according to an embodiment herein. In some embodiments, the reactor vessel 202 is configured according to the reactor vessel 104 described in reference to FIG. 1.

In some embodiments, the reactor vessel 202 has a first vessel end 206, a second vessel end 208, and a vessel wall 210 therebetween defining an interior cavity 212. In some embodiments, the reactor vessel 202 has at least one filter 214. In some embodiments, the reactor vessel 202 has a single filter 214. In some embodiments, the filter 214 comprises a mesh fuel holder or basket having cylindrically shaped interior surfaces and an open end facing the first end. In some embodiments, the reactor vessel 202 is a continuous tube reactor. In some embodiments, the reactor vessel 202 is configured to be directly above the secondary vessel 204 and configured to gravity drain all components of the reactor vessel 202 into the secondary vessel 204.

In some embodiments, the reactor vessel 202 has a first inlet 216 coupled to a first inlet 218 disposed through the first vessel end 206. In some embodiments, the first inlet 218 has an inner or outer diameter of ⅛ inches and is configured to couple with a spray nozzle 220 with at least one bulkhead or through-wall fittings. In some embodiments, at least one of the first inlet 216 and the first inlet 218 is coupled to a spray nozzle 220. In some embodiments, the continuous aluminum-water reactor system 200 has a pump 222 coupled to a control valve 224 connecting the pump 222 to first inlet 216.

In some embodiments, the reactor vessel 202 has a second inlet stream 226 configured to pass at least partially into the interior cavity 212 of the reactor. In some embodiments, the second inlet stream 226 comprises a purge gas. In some embodiments, the second inlet stream 226 is configured to provide the purge gas to the reactor vessel 202 to at least one of remove residual oxygen, control temperature, control humidity, or promote mixing from the reactor vessel 202. In some embodiments, the reactor vessel 202 operates without oxygen or with negligible amounts of oxygen.

In some embodiments, the reactor vessel 202 has a first outlet 228 coupled with a safety relief valve. In some embodiments, the first outlet 228 coupled with the safety relief valve is configured to prevent excessive pressure buildup within the reactor vessel 202 by automatically releasing excessive pressure from the reactor vessel 202. In some embodiments, the first outlet 228 is configured to exit a first outlet stream 230. In some embodiments, the reactor vessel 202 has a second outlet stream 232 configured to pass through a second outlet 234. In some embodiments, the reactor vessel 202 has a third outlet 236 disposed though the second vessel end 208 and configured to exit a third outlet stream 238. In some embodiments, at least one or both of the second outlet 234 and the third outlet 236 comprises a national pipe taper (NPT) male or female connector. In some embodiments, at least one or both of the second outlet 234 and the third outlet 236 comprises an inner or outer diameter of ¼ inches.

In some embodiments, at least one of the third outlet stream 238 and/or the second outlet stream 232 feed into a secondary vessel 204. In some embodiments, the secondary vessel 204 is a continuously stirred reaction vessel and/or catalyst recovery vessel. In some embodiments, the secondary vessel 204 is a continuously stirred tank reactor. In some embodiments, the secondary vessel 204 has a secondary vessel outlet stream 240 which leads into an additional reactor (not shown). In some embodiments, secondary vessel outlet stream 240 comprises at least one of steam, hydrogen, or steam and hydrogen. In some embodiments, water is added to the continuously stirred tank reactor to support at least one of catalyst recovery, byproduct removal, separation of solid materials, or any combination thereof. For example, the reactor vessel 202 may be configured such that essentially all water volume that is removed from the system by exiting steam or some other mechanism is replaced.

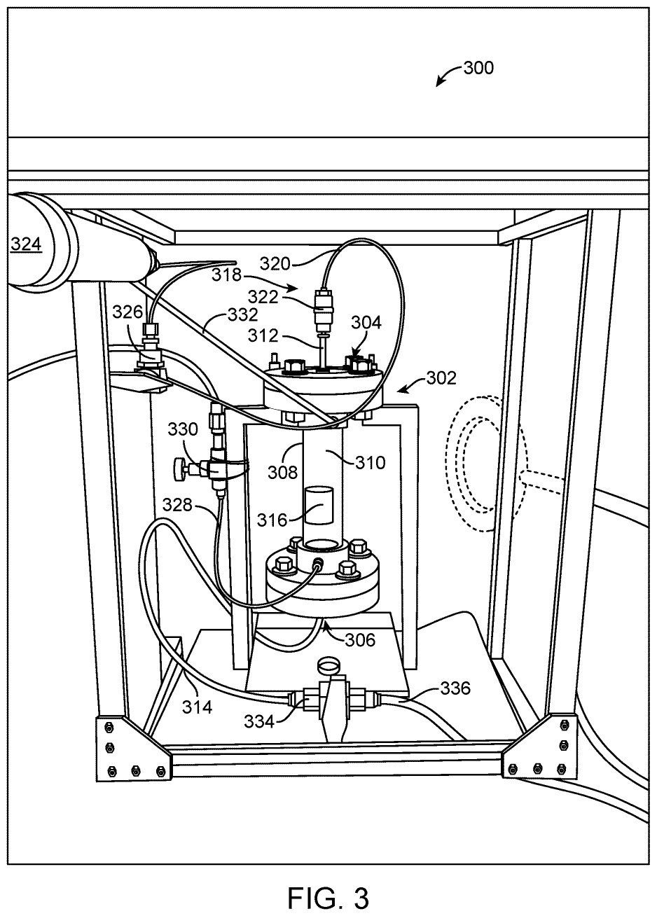

FIG. 3 illustrates a continuous aluminum-water reactor system 300 including a reactor vessel 302, according to another embodiment herein. In some embodiments, the reactor vessel 302 is configured according to the reactor vessel 104 or reactor vessel 202 as described in reference to FIG. 1 and FIG. 2, respectively.

In some embodiments, the reactor vessel 302 has a first vessel end 304, second vessel end 306, and a vessel wall 308 therebetween defining an interior cavity 310. In some embodiments, the reactor vessel 302 is a flanged tube reactor. In some embodiments, the reactor vessel 302 includes one or more sealing mechanisms configured to maintain pressure within the reactor vessel 302. In some embodiments, the first vessel end 304 comprises one or more flanges with one or more bolts to form a seal maintaining pressure within the reactor vessel 302. In some embodiments, the first vessel end 304 comprises a through hole with a seal formed through a push-to-connect type connection. In some embodiments, the push-to connect type connection has a tapered connection fitting. In some embodiments, a fluid inlet second portion 312 is configured to connect through the first vessel end 304. In some embodiments, the fluid inlet second portion 312 passes through the first vessel end 304 with a push-to-connect tapered fitting forming a seal to maintain pressure within the reactor vessel 302. In some embodiments, the fluid inlet second portion 312 is configured to connect to a spray nozzle so as to feed water into the reactor vessel 302.

In some embodiments, the reactor vessel 302 includes a third outlet 314 configured to pass at least partially through the second vessel end 306. In some embodiments, the third outlet 314 is coupled with an outlet flange. In some embodiments, the second vessel end 306 comprises a through-hole and/or piping to a compression fitting configured to couple with the third outlet 314. In some embodiments, the third outlet 314 is configured to couple with a Swagelok fitting.

In some embodiments, the vessel wall 308 surrounds an interior cavity 310 of the reactor vessel 302. In some embodiments, the interior cavity 310 includes at least one of a filter, a mesh basket 316, a spray nozzle, or a first portion of a plurality of fuel particles therein. In some embodiments, at least one filter forms a mesh basket 316 configured to retain a portion of a plurality of fuel particles. In some embodiments, the mesh basket 316 is configured to retain at least a first portion of a plurality of fuel particles while the first portion of the plurality of fuel particle are exfoliated and agitated and permit at least a portion of reaction byproduct, water, and a second portion of the plurality of fuel particles having at least one dimension smaller than the dimension of an opening in the mesh to pass through the mesh basket 316.

In some embodiments, the interior cavity 310 comprises a holder (not shown) configured to mount and/or hang the mesh basket 316. In some embodiments, the holder comprises stainless steel wire. In some embodiments, the holder is configured to be movable within the interior cavity 310 so as to adjust the position of one or more filters within the interior cavity 310. In some embodiments, the holder is configured to adjust a height of one or more filters so as to increase and/or reduce the distance between the spray nozzle and the plurality of fuel particles.

In some embodiments, a first inlet pipe 318 has a fluid inlet first portion 320 coupled to a fluid inlet second portion 312. In some embodiments, the fluid inlet first portion 320 has a diameter larger than the fluid inlet second portion 312. In some embodiments, the fluid inlet second portion 312 has a larger diameter than the fluid inlet first portion 320. In some embodiments, the fluid inlet first portion 320 is coupled with the fluid inlet second portion 312 with a reducer apparatus 322. In some embodiments, the reducer apparatus 322 comprises a reducer and/or a check valve. In some embodiments, the reducer apparatus 322 is a push-to-connect type reducer. In some embodiments, the reducer apparatus 322 is configured to prevent pressure from inside the reactor vessel 302 from pushing water back up the first inlet pipe 318 and out of the reactor vessel 302. In some embodiments, a fluid reservoir 324 is coupled to the fluid inlet first portion 320 and configured to provide fluid to the reactor vessel 302. In some embodiments, the fluid reservoir 324 is configured to retain one or more fluids. In some embodiments, the fluid reservoir 324 is configured to retain at least one fluid. For example, the fluid reservoir 324 may be configured to retain water. In some embodiments, a first control valve 326 couples the fluid inlet first portion 320 to the fluid reservoir 324. In some embodiments, the first control valve 326 is a 90 degree valve. In some embodiments, the first control valve 326 is configured to isolate the fluid reservoir 324 from the fluid inlet first portion 320 when loading the fluid reservoir 324 with one or more fluids. In some embodiments, the fluid reservoir 324 is configured to couple with a fluid inlet first portion 320 to form a pumped system for automatic loading of water.

In some embodiments, a second inlet pipe 328 is configured to at least partially be disposed through the vessel wall 308. In some embodiments, the second inlet pipe 328 is configured to provide at least one purge gas to the interior cavity 310. In some embodiments, the at least one purge gas comprises hydrogen. In some embodiments, the second inlet pipe 328 is coupled to a second control valve 330. In some embodiments, the second control valve 330 is configured to control the pressure within the reactor vessel 302. In some embodiments, the second control valve 330 is configured to provide sufficient pressure through the second inlet pipe 328 to force byproduct through at least one outlet. For example, the second control valve 330 may provide pressure to force byproduct through an outlet to remedy a clogged outlet. In some embodiments, the second control valve 330 is configured to couple with at least one water inlet. In some embodiments, the 330 is configured to control the pressure and/or flow rate of fluids entering the reactor vessel 302 in some embodiments, the second inlet pipe 328 is positioned at a location closer to the second vessel end 306 than the first vessel end 304. bottom inlet of the tube reactor. In some embodiments, the second inlet pipe 328 is configured to provide water to the reactor vessel 302.

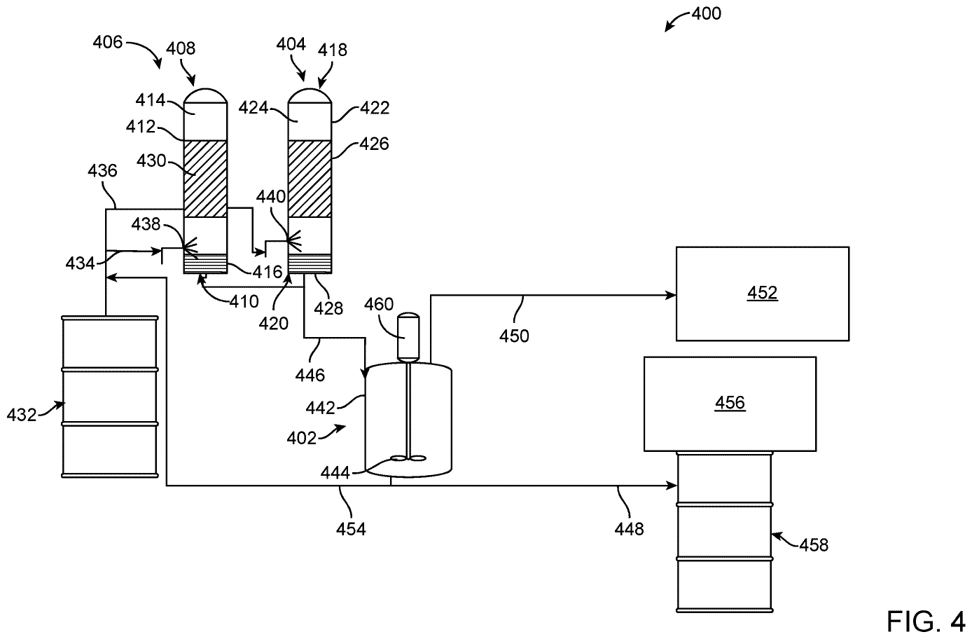

In some embodiments, a first outlet 332 is disposed at least partially through the vessel wall 308 or first vessel end 304. In some embodiments, the first outlet 332 is configured to permit one or more gasses or steam exit the reactor vessel 302. In some embodiments, the one or more gasses comprises hydrogen. In some embodiments, the first outlet 332 is coupled with a sensor configured to measure the amount of gas, hydrogen, steam, or any combination thereof exiting the reactor. In some embodiments, the first outlet 332 is configured to be routed to a secondary container for storage and/or utilization (see FIG. 4). In some embodiments, the hydrogen produced from the reactor vessel 302 is used to produce energy.

In some embodiments, a third outlet 314 is disposed at least partially through the second vessel end 306. In some embodiments, the third outlet 314 is coupled to a third control valve 334. In some embodiments, the third control valve 334 is configured to control the flow of byproduct and/or water out of the reactor vessel 302. In some embodiments, the third control valve 334 includes or is coupled with or includes at least one sensor to determine the level of byproduct in the third outlet 314. In some embodiments, the third control valve 334 includes or is coupled with at least one processor to determine when the third control valve 334 should be open to permit byproduct and/or water to exit the reactor vessel 302 and when the third control valve 334 should be closed based. In some embodiments, the processor determines if the third control valve 334 should be open based on the concentration of byproduct in third outlet 314. In some embodiments, the third control valve 334 is configured to be in an open position when the reactor vessel 302 is at or above atmospheric pressure such as to allow for gravity and/or pressure drain at least a portion of water and byproduct. In some embodiments, the third control valve 334 is coupled with the third outlet 314 and a downstream inlet 336. In some embodiments, the downstream inlet 336 is configured to transport water and/or byproduct from the reactor vessel 302 to a downstream continuously stirred reaction vessel and/or catalyst recovery vessel (see FIG. 2). In some embodiments, the downstream inlet 336 is configured to transport water and/or byproduct from the reactor vessel 302 to a downstream location bypassing the continuously stirred reaction vessel and/or catalyst recovery vessel (see FIG. 2).

In some embodiments, at least one of the first control valve 326, second control valve 330, third control valve 334, or check valve portion of the reducer apparatus 322 comprises at least one fitting configured to couple the respective valve with an inlet and/or outlet. In some embodiments, the fitting is a push-to-connect fitting. In some embodiments, at least one of the first control valve 326, second control valve 330, or third control valve 334 comprises a globe valve, a ball valve, a check valve, a gate valve, or any combination thereof.

FIG. 4 illustrates a diagram of a continuous aluminum-water reactor system 400 having a stirred buffer tank 402, a first reactor vessel 404, and a second reactor vessel 404 arranged in parallel with the first reactor vessel 406. In some embodiments, the stirred buffer tank 402 is a continuously stirred reaction vessel and/or catalyst recovery vessel. In some embodiments, at least one of the first reactor vessel 406 and second reactor vessel 404 are tube reactors. In some embodiments, at least one of the first reactor vessel 406 and second reactor vessel 404 are configured according to the reactor vessel 104, reactor vessel 202, or reactor vessel 302 described in reference to FIG. 1, FIG. 2, and FIG. 3, respectively.

In some embodiments, the first reactor vessel 406 comprises a first reactor first vessel end 408, a first reactor second vessel end 410, and a first reactor vessel wall 412 therebetween defining a first reactor vessel interior cavity 414. In some embodiments, the first reactor vessel 406 includes a plurality of fuel particles disposed within the first reactor vessel interior cavity 414. In some embodiments, the first reactor vessel 406 further comprises at least one first reactor vessel filter 416.

In some embodiments, the second reactor vessel 404 comprises a second reactor vessel first end 418, a second reactor second vessel end 420 and a second reactor vessel wall 422 therebetween defining a second reactor vessel interior cavity 424. In some embodiments, the second reactor vessel 404 includes a second reactor vessel plurality of fuel particles 426 disposed within the second reactor vessel interior cavity 424. In some embodiments, the second reactor vessel 404 further comprises at least one second reactor vessel filter 428.

In some embodiments, the temperature and pressure are individually controlled in the first reactor vessel 406 and the second reactor vessel 404. In some embodiments, the first reactor vessel plurality of fuel particles 430 and the second reactor vessel plurality of fuel particles 426 comprises aluminum fuel trays, aluminum fuel pellets, aluminum pucks, aluminum briquettes, or any combination thereof. In some embodiments, at least one of the first reactor vessel filter 416 and the second reactor vessel filter 428 is a coarse mesh. In some embodiments, the first reactor vessel plurality of fuel particles 430 and the second reactor vessel plurality of fuel particles 426 each form a fixed bed reactor within the first reactor vessel 406 and the second reactor vessel 404, respectively.

In some embodiments, the continuous aluminum-water reactor system 400 comprises a first water drum 432. In some embodiments, the first water drum 432 is configured to provide water through first and second inlet streams 434, 436 to the first reactor vessel 406 and the second reactor vessel 404 in parallel. In some embodiments, the first reactor inlet stream 434 is configured to couple with a first reactor spray nozzle 438 to provide water to the first reactor vessel 406. In some embodiments, the second reactor inlet stream 436 is configured to couple with a second reactor spray nozzle 440 to provide water to the second reactor vessel 404. In some embodiments, the second reactor spray nozzle 440 is configured to control foaming behaviors of byproducts. In some embodiments, the water provided from the first water drum 432 is deionized water.

In some embodiments, the second reactor vessel 404 is a continuously stirred reaction vessel and/or catalyst recovery vessel. For example, the second reactor vessel 404 illustrated in FIG. 4 is configured as a continuously stirred reaction vessel having a jacket 442, an agitator 444, and motor. In some embodiments, the stirred buffer tank 402 is configured to be stirred by a motor-driven paddle mixer, an impeller, a liquid jet, liquid eductor, or any combination thereof. In some embodiments, the third outlet 446 from at least one of first reactor vessel 406 and second reactor vessel 404 feed into the second reactor vessel 404. In some embodiments, the third outlet 446 from both the first reactor vessel 406 and second reactor vessel 404 feed into the second reactor vessel 404. In some embodiments, the third outlet 446 comprises at least one of hydrogen, steam, sludge, or any combination thereof. In some embodiments, the secondary vessel 402 is configured to mix water and byproduct from the first and second reactor vessels 406, 404 until the reagents are fully reacted after a high-power stage. In some embodiments, water is added to the second reactor vessel 404 to support at least one of catalyst recovery, byproduct removal, separation of solid materials, or any combination thereof.

In some embodiments, the second reactor vessel 404 has a heavy outlet stream 448 and a light outlet stream 450. In some embodiments, the light outlet stream 450 is composed of a higher composition of volatile or gaseous byproducts compared to the heavy outlet stream 448. In some embodiments, the light outlet stream 450 comprises hydrogen, steam, or hydrogen and steam. In some embodiments, the light outlet stream 450 is configured to feed into a light stream vessel 452. In some embodiments, the light stream vessel 452 is configured to separate, purify, store, use, or any combination thereof the light outlet stream 450.

In some embodiments, the primarily liquid and solid components exiting the second reactor vessel 404 splits into two outlet streams: the water recirculation line 454 and the heavy outlet stream 448. In some embodiments, the heavy outlet stream 448 comprises water, an inert sludge, and/or a slurry. For example, inert sludge and/or the slurry may comprise water and inert solid particles such as inert, reacted aluminum. In some embodiments, heavy outlet stream 448 is configured to feed into a heavy stream vessel 456. In some embodiments, the heavy stream vessel 456 is configured to separate, purify, store, use, or any combination thereof the heavy outlet stream 448. For example, the heavy stream vessel 456 may be coupled with a second water drum 458 for storage. In some embodiments, the heavier byproducts from the heavy outlet stream 448 are collected based on gravimetric separation.

In some embodiments, the water recirculation line 454 exits the secondary vessel 402 and recirculates into at least one of the first reactor inlet stream 434 and the second reactor inlet stream 436 until the byproducts have fully reacted if a desired power output is achieved. In some embodiments, the water is recirculated back in the stirred buffer tank 402 through a continuous filter or solid/liquid separation device such as hydrocyclone. In some embodiments, the water is recirculated back into the first water drum 432 through a continuous filter or solid/liquid separation device such as a hydrocyclone. In some embodiments, the recirculated water is mixed with a concentrated stream of dissolved additives from a separate vessel to adjust the pH and/or concentrations of solutes of the vessels and/or inlet streams. In some embodiments, the recirculation flow is driven by a pressure differential between the stirred buffer tank 402 and the receiving vessel. In some embodiments, the recirculation flow is driven by a fluidic pump located between the stirred buffer tank 402 and the filter system or receiving vessel. In some embodiments, the fluidic pump is a centrifugal pump, a diaphragm pump, a progressive cavity pump, or any other fluidic pump that can transport solid particles larger than 10 μm.

In some embodiments, the contents of the second water drum 458 are separately recirculated to the stirred buffer tank 402 or the first water drum 432 through a continuous filter or solid/liquid separation device such as a hydrocyclone.

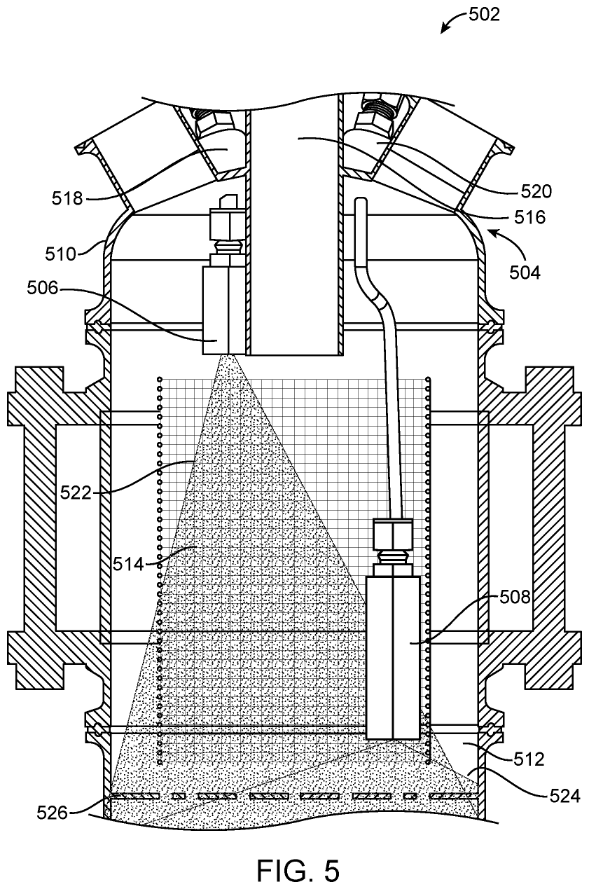

FIG. 5 illustrates an example of a continuous aluminum-water reactor system 502 having a reactor vessel 504 retaining a first spray nozzle 506 and a second spray nozzle 508. For example, the reactor vessel 504 may have the characteristics of the reactor vessel 104 as shown in FIG. 1, the reactor vessel 202 as shown in FIG. 2, the reactor vessel 302 as shown in FIG. 3, or the first reactor vessel 406 and/or second reactor vessel 404 as shown in FIG. 4.

As shown in FIG. 5, for example, the continuous aluminum-water reactor system 502 has a reactor vessel 504 comprising a reactor outer surface 510 defining a reactor interior cavity 512 configured to receive at least one mesh basket 514. In some embodiments, the continuous aluminum-water reactor system 502 has a fuel inlet 516 extending through the reactor outer surface 510 at a proximal end of the continuous aluminum-water reactor system 502 and at least partially into the reactor interior cavity 512. In some embodiments, the fuel inlet 516 extends through a longitudinal axis of the continuous aluminum-water reactor system 502. In some embodiments, the continuous aluminum-water reactor system 502 has a mesh basket 514 located within the reactor interior cavity 512. In some embodiments, the mesh basket 514 has a substantially cylindrical shape with an open proximal end. In some embodiments, the continuous aluminum-water reactor system 502 is configured such that the open proximal end of the mesh basket 514 is located in line with the fuel inlet 516 so any fuel particles exiting the fuel inlet 516 will fall into the mesh basket 514.

In some embodiments, a first inlet pipe 518 is located adjacent to or interfacing with the fuel inlet 516. For example, the first inlet pipe 518 may also pass through the proximal end of the reactor outer surface 510 of the reactor vessel 504. In some embodiments, a first spray nozzle 506 extends distally from the distal end of the first inlet pipe 518 within the reactor interior cavity 512. In some embodiments, the distal end of the first spray nozzle 506 is located proximal to and spaced apart from the proximal end of the mesh basket 514.

In some embodiments, a second inlet pipe 520 is located adjacent to or interfacing with the fuel inlet 516. For example, the second inlet pipe 520 may also pass through the proximal end of the reactor outer surface 510 of the reactor vessel 504. In some embodiments, a second spray nozzle 508 extends distally from the distal end of the second inlet pipe 520 within the reactor interior cavity 512. In some embodiments, the distal end of the second spray nozzle 508 at least partially extends into the mesh basket 514. In some embodiments, the second spray nozzle 508 is disposed entirely within the mesh basket 514. In some embodiments, the second spray nozzle 508 is disposed entirely within the mesh basket 514 and spaced apart from the walls of the mesh basket 514. In some embodiments, the second spray nozzle 508 is disposed in the reactor interior cavity 512 at a location between the proximal end of the mesh basket 514 and the distal end of the mesh basket 514 and exterior to and spaced apart from the outer walls of the mesh basket 514.

In some embodiments, the first inlet pipe 518 and the second inlet pipe 520 are arranged symmetrically about the circumference of the fuel inlet 516. In other words, in some embodiments, the first inlet pipe 518 and the second inlet pipe 520 are opposite one another and equally spaced around the fuel inlet 516.

In some embodiments, the first spray nozzle 506 is configured to emit a first spray plume 522. In some embodiments, the second spray nozzle 508 is configured to emit a second spray plume 524. In some embodiments, the first spray plume 522 and/or the second spray plume 524 has a substantially cone-like shape. In some embodiments, the first spray nozzle 506 is configured to emit the first spray plume 522 in a direction parallel to the longitudinal axis of the reactor vessel 504. In some embodiments, the second spray nozzle 508 is configured to emit the second spray plume 524 in a direction parallel to the longitudinal axis of the reactor vessel 504. FIG. 5 illustrates an example of the first spray plume 522 retained within the reactor outer surface 510 of the reactor vessel 504 to illustrate the shape of the first spray plume 522, any droplets and/or particles emitted from the first spray nozzle 506 within the first spray plume 522 would be entirely retained within the reactor outer surface 510 until exiting the reactor outer surface 510 through an outlet. In some embodiments, the location and orientation of the first spray nozzle 506 and the second spray nozzle 508 are configured to provide a desired volume and flow rate of fluid to the distal end of the mesh basket 514. For example, the location and orientation of the first spray nozzle 506 and the second spray nozzle 508 may be configured to maximize fluid emitted onto the distal end of the mesh basket 514 retaining a plurality of fuel particles.

In some embodiments, the first spray nozzle 506 and/or the second spray nozzle 508 are configured to emit a fluid. For example, the first spray nozzle 506 and/or the second spray nozzle 508 may be configured to provides uniform and good dispersal of the slurry or fluid droplets throughout the first spray plume 522 and/or the second spray plume 524.

In some embodiments, the first spray nozzle 506 and/or the second spray nozzle 508 are configured to emit a plume of aerosolized liquid droplets (aerosols) having a preselected average size. In some embodiments, the first spray nozzle 506 and/or the second spray nozzle 508 are configured to emit a stream of fluid. In some embodiments, the first spray nozzle 506 and/or the second spray nozzle 508 are selected from a group consisting of nebulizers, atomizers, misters, injectors, specialized nozzles, nozzles, and any combination thereof. Other nozzles known to those skilled in the art may be used to emit a plume of fluid within the reactor interior cavity 512.

In some embodiments, the first spray nozzle 506 and the second spray nozzle 508 are configured to deliver different volumes and/or flowrates of water or activation fluid into the reactor vessel 504. In some embodiments, the first spray nozzle 506 and the second spray nozzle 508 are configured to deliver the same volume and/or flowrate of water or activation fluid into the reactor vessel 504. For example, the activation fluid may comprise water and a catalyst.

In some embodiments, the water flow supplied through the first spray nozzle 506 and the second spray nozzle 508 is configured to correlate with and complement the average particle size in each vessel region. In some embodiments, the water flow supplied through the first spray nozzle 506 and/or the second spray nozzle 508 is configured to compliment the mass/volume of fuel and its reaction contained within each vessel region. For example, the water flow may be pulsed to allow for exfoliation of the fuel particles. In some embodiments, the water flow is constant to facilitate bulk movement of the fuel particles within the continuous aluminum-water reactor system 502. In some embodiments, the fluid flow supplied through the first spray nozzle 506 and/or the second spray nozzle 508 is configured at different pressures, bulk temperatures, pH, and fluid substance to impart a variety of results on the reaction. In some embodiments, the first inlet pipe 518 and the second inlet pipe 520 are configured to draw from different vessel sources.

In some embodiments, the water inlet velocity from the first spray nozzle 506 and the second spray nozzle 508 is configured to match a targeted specification. In some embodiments, the inlet velocity supplied through the first spray nozzle 506 and the second spray nozzle 508 at the top of the continuous aluminum-water reactor system 502 is configured to be lower than the inlet velocity supplied through the first spray nozzle 506 and the second spray nozzle 508 at the bottom of the continuous aluminum-water reactor system 502. In some embodiments, the water inlet flow rate from the first spray nozzle 506 and the second spray nozzle 508 is configured to match a targeted specification. In some embodiments, the flow rate supplied through the first spray nozzle 506 and the second spray nozzle 508 at the top of the continuous aluminum-water reactor system 502 is configured to be lower than the flow rate supplied through the first spray nozzle 506 and the second spray nozzle 508 at the bottom of the continuous aluminum-water reactor system 502. In some embodiments, the first spray nozzle 506 and the second spray nozzle 508 are oriented to achieve bulk movement and hydration of the fuel and byproducts. For example, the first spray nozzle 506 and the second spray nozzle 508 may be oriented to spray downward in the direction of intended particle motion, directly transverse to intended particle motion, upward against the intended particle motion, or any combination thereof.

In some embodiments, the first spray nozzle 506 and the second spray nozzle 508 are configured to have specific spray configurations to accomplish hydration and bulk movement of fuel and byproduct. For example, the spray configurations may be full cone sprays at many angles. For example, the spray cone may be positioned at an angle between 45-60 degrees, 60-90 degrees, or 90-120 degrees relative to the longitudinal axis of the reactor interior cavity 512. In some embodiments, at least one of the spray cones is positioned at an angle 45 degrees, 60 degrees, 90 degrees, or 120 degrees relative to the longitudinal axis of the reactor interior cavity 512.

In some embodiments, a combination of the first spray nozzle 506 and the second spray nozzle 508 are configured to fully hydrate the reactor surface area or a portion thereof. In some embodiments, the first spray nozzle 506 and the second spray nozzle 508 are high impact deflection nozzles used to clear material from the continuous aluminum-water reactor system 502.

In some embodiments, the fluid supplies to at least one of the first spray nozzle 506, second spray nozzle 508, the first inlet pipe 518, and the second inlet pipe 520 are configured to be controlled by one or more control valves connected to a pump (not shown). In some embodiments, the control valve is a solenoid valve. In some embodiments, the pumps supply water to a plurality of spray nozzles, each coupled to a control valve. In some embodiments, a single control valve is configured to control water supply to a plurality of spray nozzles. In some embodiments, a single spray nozzle is configured to receive water supplies from a plurality of control valves. In some embodiments, the pumps are configured to couple with a fluidic accumulator to help maintain pressure and water flow rates during operation of the control valve. In some embodiments, the pumps are variable speed pumps that can control water flow rate independently of water pressure. In some embodiments, the pumps are fixed speed pumps. In some embodiments, the pumps are operated continuously to maintain pressure and flow rate. In some embodiments, the pumps are operated intermittently to maintain pressure and flow rate. In some embodiments, the pumps are any pumps capable of pumping fluid. For example, the pumps may be gear pumps, diaphragm pumps, piston pumps, or centrifugal pumps.

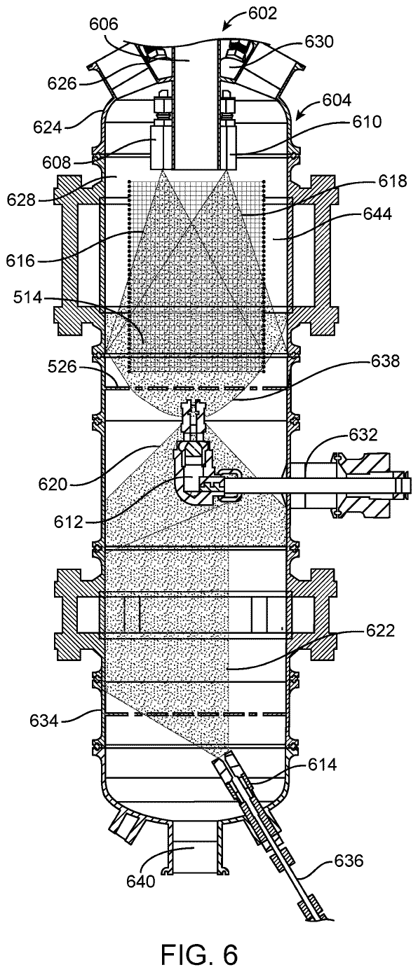

FIG. 6 illustrates a cross-sectional view of an exemplary continuous aluminum-water reactor system 602 having a reactor vessel 604 retaining a fuel inlet 606, a first spray nozzle 608, a second spray nozzle 610, a third spray nozzle 612, and a fourth spray nozzle 614. In some embodiments, the continuous aluminum-water reactor system 602 is the continuous aluminum-water reactor system 502 shown in FIG. 5, with additional spray nozzles, different locations of spray nozzles, and/or orientation of spray nozzles. In some embodiments, the fuel inlet 606 and the second spray nozzle 610 are configured to spray a 60 degree full cone in respective first spray plume 616.

FIG. 6 illustrates an example of the first spray plume 616, the second spray plume 618, the third spray plume 638, the fourth spray plume 620, and the fifth spray plume 622 are retained within the reactor outer surface 624 of the reactor vessel 604 and shown in an exemplary cone shape to illustrate exemplary shapes of the spray plumes, however, any droplets and/or particles emitted from the first spray plume 616, the second spray plume 618, the third spray plume 638, the fourth spray plume 620, and the fifth spray plume 622 would be entirely retained within the reactor walls until exiting the reactor outer surface 510 through an outlet 640. The respective plumes would extend from the respective nozzle, for example, in a cone-like shape, until they hit the reactor outer surface and/or the exiting momentum of the droplets from the nozzle is overcome by gravity, whereafter the droplets would progress towards the bottom of the reactor system 602. The cone-like shape of the plume is illustrative of one embodiment, and is not limiting to shape of the plume in other embodiments.

In some embodiments, a first inlet pipe 626 is located adjacent to or interfacing with the fuel inlet 606. For example, the first inlet pipe 626 may also pass through the proximal end of the reactor outer surface 624 of the reactor vessel 604. In some embodiments, the first spray nozzle 608 extends distally from the distal end of the first inlet pipe 626 within the reactor interior cavity 628. In some embodiments, the distal end of the first inlet pipe 626 is located proximal to and spaced apart from the proximal end of the mesh basket 514.

In some embodiments, a second inlet pipe 630 is located adjacent to or interfacing with the fuel inlet 606. For example, the second inlet pipe 630 may also pass through the proximal end of the reactor outer surface 624 of the reactor vessel 604. In some embodiments, the second spray nozzle 610 extends distally from the distal end of the second inlet pipe 630 within the reactor interior cavity 628. In some embodiments, the first spray nozzle 608 and the second spray nozzle 610 are configured such that their distal ends are above the distal end of the mesh basket 514. In some embodiments, the distal ends of the first spray nozzle 608 and the second spray nozzle 610 at least partially extends into the mesh basket 514. In some embodiments, the first spray nozzle 608 and the second spray nozzle 610 are disposed entirely within the mesh basket 514. In some embodiments, the first spray nozzle 608 and the second spray nozzle 610 are disposed entirely within the mesh basket 514 and spaced apart from the walls of the mesh basket 514. In some embodiments, the first spray nozzle 608 and the second spray nozzle 610 are disposed in the reactor interior cavity 628 at a location between the proximal end of the mesh basket 514 and the distal end of the mesh basket 514 and exterior to and spaced apart from the outer walls of the mesh basket 514.

In some embodiments, the first inlet pipe 626 and the second inlet pipe 630 are arranged symmetrically about the circumference of the fuel inlet 606. In other words, in some embodiments, the first inlet pipe 626 and the second inlet pipe 630 are opposite one another and equally spaced around the fuel inlet 606. In some embodiments, the first inlet pipe 626 and the second inlet pipe 630 are configured to run in parallel to the longitudinal axis of the reactor interior cavity 628. In some embodiments, a plurality of inlet pipes is disposed at least partially within the reactor interior cavity 628. In some embodiments, pipes within the plurality of inlet pipes are arranged with radial symmetry to each other around the fuel inlet 606.

In some embodiments, a third inlet pipe 632 is configured to extend through the reactor outer surface 624. In some embodiments, the third inlet pipe 632 is located near the middle of the reactor vessel 604. In some embodiments, the third inlet pipe 632 extends perpendicular to the longitudinal axis of the reactor interior cavity 628, In some embodiments, the third spray nozzle 612 is attached to the distal end of the third inlet pipe 632. In some embodiments, the third spray nozzle 612 is configured to between the first filter 526 and a second filter 634. In some embodiments, the third spray nozzle 612 is configured to run in parallel with the longitudinal axis of the reactor interior cavity 628, forming a right angle with the third inlet pipe 632. In some embodiments, majority of the third spray nozzle 612 is configured to run in parallel with the longitudinal axis of the reactor interior cavity 628, forming a right angle with the third inlet pipe 632.

In some embodiments, a fourth inlet pipe 636 is configured to extend through the reactor outer surface 624. In some embodiments, the fourth inlet pipe 636 extends through the bottom of the continuous aluminum-water reactor system 602 into the reactor vessel 604. In some embodiments, the fourth inlet pipe 636 extends through a portion of the reactor vessel 604 located closer to the bottom of the reactor vessel 604 than the top of the reactor vessel 604. In some embodiments, the fourth spray nozzle 614 is attached to the distal end of the fourth inlet pipe 636. In some embodiments, the fourth spray nozzle 614 is configured to be below the second filter 634 and spray upwards into the reactor vessel 604. In some embodiments, the fourth spray nozzle 614 is configured at an angle to the longitudinal axis of the reactor interior cavity 628. For example, the spray cone may be positioned at an angle between 45-60 degrees, 60-90 degrees, or 90-120 degrees relative to the longitudinal axis of the reactor interior cavity 628.

In some embodiments, the first spray nozzle 608 is configured to emit a first spray plume 616. In some embodiments, the second spray nozzle 610 is configured to emit a second spray plume 618. In some embodiments, the third spray nozzle 612 is configured to emit a third spray plume 638 and a fourth spray plume 620. In some embodiments, the fourth spray nozzle 614 is configured to emit a fifth spray plume 622. In some embodiments, the first spray plume 616, second spray plume 618, third spray plume 638, fourth spray plume 620, and/or fifth spray plume 622 has a substantially cone-like shape. In some embodiments, the first spray nozzle 608 is configured to emit the first spray plume 616 in a direction parallel to the longitudinal axis of the reactor vessel 604. In some embodiments, the second spray nozzle 610 is configured to emit the second spray plume 618 in a direction parallel to the longitudinal axis of the reactor vessel 604. In some embodiments, the third spray nozzle 612 is configured to emit the third spray plume 638 and the fourth spray plume 620 in a direction parallel to the longitudinal axis of the reactor vessel 604. In some embodiments, the fourth spray nozzle 614 is configured to emit the fifth spray plume 622 in a direction at an angle to the longitudinal axis of the reactor vessel 604. In some embodiments, at least one of the first spray nozzle 608, the second spray nozzle 610, the third spray nozzle 612, and the fourth spray nozzle 614 is configured to emit a spray plume radially outward with respect to the longitudinal axis of the reactor vessel 604. In some embodiments, at least one of the first spray nozzle 608, the second spray nozzle 610, the third spray nozzle 612, and the fourth spray nozzle 614 is configured to emit a spray plume in a direction parallel to the longitudinal axis of the reactor vessel 604.

FIG. 6 illustrates an example of the first spray plume 616 extending beyond the reactor outer surface 624 of the reactor vessel 604 to illustrate the shape of the first spray plume 616, however, any droplets and/or particles emitted from the first spray nozzle 608 within the first spray plume 616 would be entirely retained within the reactor outer surface 624 until exiting the reactor outer surface 624 through an outlet 640. In some embodiments, the location and orientation of the first spray nozzle 608 and the second spray nozzle 610 are configured to provide a desired volume and flow rate of fluid to the distal end of the mesh basket 514. For example, the location and orientation of the first spray nozzle 608 and the second spray nozzle 610 may be configured to maximize fluid emitted onto the distal end of the mesh basket 514 retaining a plurality of fuel particles.

In some embodiments, the first spray nozzle 608, the second spray nozzle 610, the third spray nozzle 612, and the fourth spray nozzle 614 are configured to emit a fluid. For example, the first spray nozzle 608, the second spray nozzle 610, the third spray nozzle 612, and/or the fourth spray nozzle 614 may be configured to provide uniform and good dispersal of the slurry or fluid droplets throughout the first spray plume 616, second spray plume 618, third spray plume 638, fourth spray plume 620, and fifth spray plume 622.

In some embodiments, the first spray nozzle 608, the second spray nozzle 610, the third spray nozzle 612, and the fourth spray nozzle 614 are configured to emit a plume of aerosolized liquid droplets (aerosols) having a preselected average size. In some embodiments, the first spray nozzle 608, the second spray nozzle 610, the third spray nozzle 612, and the fourth spray nozzle 614 are selected from a group consisting of nebulizers, atomizers, misters, injectors, specialized nozzles, nozzles, and any combination thereof. Other nozzles known to those skilled in the art may be used to emit a plume of fluid within the reactor interior cavity 628.

In some embodiments, the first spray nozzle 608, the second spray nozzle 610, the third spray nozzle 612, and the fourth spray nozzle 614 are configured to deliver different volumes and/or flowrates of water or activation fluid into the reactor vessel 604. In some embodiments, the first spray nozzle 608, the second spray nozzle 610, the third spray nozzle 612, and the fourth spray nozzle 614 are configured to deliver the same volume and/or flowrate of water or activation fluid into the reactor vessel 604. For example, the activation fluid may comprise water and a catalyst.

In some embodiments, the water flow supplied through the first spray nozzle 608, the second spray nozzle 610, the third spray nozzle 612, and the fourth spray nozzle 614 is configured to correlate with and complement the average particle size in each vessel region. In some embodiments, the water flow supplied through the first spray nozzle 608, the second spray nozzle 610, the third spray nozzle 612, and the fourth spray nozzle 614 is configured to compliment the mass/volume of fuel and its reaction contained within each vessel region. For example, the water flow may be pulsed to allow for exfoliation of the fuel particles. In some embodiments, the water flow is constant to facilitate bulk movement of the fuel particles within the third spray plume continuous aluminum-water reactor system 602. In some embodiments, the fluid flow supplied through the first spray nozzle 608, the second spray nozzle 610, the third spray nozzle 612, and the fourth spray nozzle 614 is configured at different pressures, bulk temperatures, pH, and fluid substance to impart a variety of results on the reaction. In some embodiments, the first inlet pipe 626, the second inlet pipe 630, the third inlet pipe 632, and the fourth inlet pipe 636 are configured to draw from different vessel sources.

In some embodiments, the water inlet velocity from the first spray nozzle 608, the second spray nozzle 610, the third spray nozzle 612, and the fourth spray nozzle 614 is configured to match a targeted specification. In some embodiments, the flow rate supplied through the first spray nozzle 608, the second spray nozzle 610, the third spray nozzle 612, and the fourth spray nozzle 614 at the top of the continuous aluminum-water reactor system 602 is configured to be lower than the flow rate supplied through the first spray nozzle 608, the second spray nozzle 610, the third spray nozzle 612, and the fourth spray nozzle 614 at the bottom of the continuous aluminum-water reactor system 602. In some embodiments, the first spray nozzle 608, the second spray nozzle 610, the third spray nozzle 612, and the fourth spray nozzle 614 are oriented to achieve bulk movement and hydration of the fuel and byproducts. For example, the first spray nozzle 608, the second spray nozzle 610, the third spray nozzle 612, and the fourth spray nozzle 614 may be oriented to spray downward in the direction of intended particle motion, directly transverse to intended particle motion, upward against the intended particle motion, or any combination thereof.

In some embodiments, the first spray nozzle 608, the second spray nozzle 610, the third spray nozzle 612, and the fourth spray nozzle 614 are configured to have specific spray configurations to accomplish hydration and bulk movement of fuel and byproduct. For example, the spray configurations may be full cone sprays at many angles. For example, the spray cone may be positioned at an angle between 45-60 degrees, 60-90 degrees, or 90-120 degrees relative to the longitudinal axis of the reactor interior cavity 628. In some embodiments, at least one of the spray cones is positioned at an angle 45 degrees, 60 degrees, 90 degrees, or 120 degrees relative to the longitudinal axis of the reactor interior cavity 628.

In some embodiments, a combination of the first spray nozzle 608, the second spray nozzle 610, the third spray nozzle 612, and the fourth spray nozzle 614 are configured to fully hydrate the reactor surface area or a portion thereof. In some embodiments, the first spray nozzle 608, the second spray nozzle 610, the third spray nozzle 612, and the fourth spray nozzle 614 are high impact deflection nozzles used to clear material from the continuous aluminum-water reactor system 602.

In some embodiments, the fluid supplies to at least one of the first spray nozzle 608, the second spray nozzle 610, the third spray nozzle 612, the fourth spray nozzle 614. the first inlet pipe 626, the second inlet pipe 630, the third inlet pipe 632, and the fourth inlet pipe 636 are configured to be controlled by one or more control valves connected to a pump. In some embodiments, the pump is the pump or plurality of pumps described in reference to FIG. 5.

Certain examples of the present disclosure were described above. It is, however, expressly noted that the present disclosure is not limited to those examples, but rather the intention is that additions and modifications to what was expressly described herein are also included within the scope of the disclosed examples. Moreover, it is to be understood that the features of the various examples described herein were not mutually exclusive and may exist in various combinations and permutations, even if such combinations or permutations were not made express herein, without departing from the spirit and scope of the disclosed examples. In fact, variations, modifications, and other implementations of what was described herein will occur to those of ordinary skill in the art without departing from the spirit and the scope of the disclosed examples. As such, the disclosed examples are not to be defined only by the preceding illustrative description.

In the appended claims, the terms “including” and “in which” are used as the plain-English equivalents of the respective terms “comprising” and “wherein,” respectively. Moreover, the terms “first,” “second,” “third,” and so forth, are used merely as labels and are not intended to impose numerical requirements on their objects.

The foregoing description of examples has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner and may generally include any set of one or more limitations as variously disclosed or otherwise demonstrated herein.

What is claimed is:

1. A continuous aluminum-water reactor system comprising:
a reactor vessel comprising,
(a) a first vessel end,
(b) a second vessel end,
(c) a vessel wall defining an interior cavity between the first vessel end and the second vessel end, and
(d) a first filter having a first mesh size and disposed within the interior cavity and configured to at least partially retain a first portion of a first plurality of fuel particles having a first average size, a first maximum size or first range of sizes;
a first spray nozzle configured to spray a fluid on the first plurality of fuel particles to breakdown, agitate, and/or react the fuel particles to transform the first plurality of fuel particles to byproducts capable of passing through the first filter; and
a first outlet at least partially disposed through the second vessel end of the reactor vessel and configured to allow one or more byproducts capable of passing through the first filter to exit the reactor vessel.

2. The continuous aluminum-water reactor system of claim 1, wherein the byproducts comprise reacted aluminum, aluminum oxide, aluminum hydroxide, aluminum oxyhydroxide or a combination of two or more thereof.

3. The continuous aluminum-water reactor system of claim 1 or 2, wherein the first spray nozzle is coupled with an inlet pipe passing through the vessel wall so as to provide the fluid to the first spray nozzle.

4. The continuous aluminum-water reactor system of any one of claims 1 to 3, wherein the first outlet is configured to exit byproducts, liquid, gas, steam, or a combination of two or more thereof.

5. The continuous aluminum-water reactor system of any one of claims 1 to 4, comprising a second filter having a second mesh size and configured to retain a second portion of the plurality of fuel particles having a second average size, a second maximum size, or second range of sizes smaller than the first average size, first maximum size, or first range of sizes, respectively, of the first plurality of fuel particles, wherein the second mesh size is finer than the first mesh size.

6. The continuous aluminum-water reactor system of claim 5, comprising a third filter having a third mesh size and configured to retain a third portion of the plurality of fuel particles, wherein the third mesh size is finer than both the second mesh size and the first mesh size,

7. The continuous aluminum-water reactor system of claim 6, comprising a fourth filter having a fourth mesh size and configured to retain a fourth portion of the plurality of fuel particles, wherein the fourth mesh size is finer than each of the first mesh size, the second mesh size, and the third mesh size.

8. The continuous aluminum-water reactor system of any one of claims 1 to 7, wherein at least one of the first filter, the second filter, the third filter, and the fourth filter is configured to separate at least one reaction byproduct from the plurality of fuel particles.

9. The continuous aluminum-water reactor system of any one of claims 1 to 8, comprising at least one of a continuously stirred reaction vessel and a catalyst recovery vessel.

10. The continuous aluminum-water reactor system of claim 9, wherein at least one of a first outlet and the second outlet feed into the at least one of the continuously stirred reaction vessel and the catalyst recovery vessel.

11. The continuous aluminum-water reactor system of any one of claims 1 to 10, comprising a second outlet at least partially disposed through the vessel wall, wherein the first outlet is coupled with a first control valve and a second outlet is coupled to a second control valve, and wherein at least one of the first control valve and the second control valve is configured to transition between an open configuration which is configured to exit an outlet stream and a closed configuration which is configured to block fluid communication through the valve.

12. The continuous aluminum-water reactor system of claim 11, wherein the secondary vessel is the continuously stirred reaction vessel having an agitator and configured to react a plurality of reactive byproducts from the first outlet and the second outlet completely.

13. The continuous aluminum-water reactor system of claim 11, wherein the first outlet is configured to release at least one of hydrogen and steam from the reactor vessel.

14. The continuous aluminum-water reactor system of claim 12, wherein water is added to the continuously stirred reaction vessel to support at least one of catalyst recovery, byproduct removal, separation of solid materials, or any combination thereof.

15. The continuous aluminum-water reactor system of any one of claims 1 to 14, comprising a second spray nozzle at least partially disposed in the interior cavity and a fuel inlet configured to at least partially pass through the vessel wall, thereby forming an opening through which to enter the first plurality of fuel particles.

16. The continuous aluminum-water reactor system of claim 15, wherein the second spray nozzle is located at a position between a first end of a mesh basket and a second end of the mesh basket within the reactor vessel.

17. The continuous aluminum-water reactor system of claim 15, comprising a third spray nozzle at least partially disposed in the interior cavity.

18. The continuous aluminum-water reactor system of claim 17, wherein the third spray nozzle is located distal to the first spray nozzle, the second spray nozzle, and/or the first filter distal end.

19. The continuous aluminum-water reactor system of claim 17, comprising a fourth spray nozzle at least partially disposed in the interior cavity.

20. The continuous aluminum-water reactor system of claim 19, wherein the fourth spray nozzle is located distal to the distal end of the filter closest to the outlet in the reactor vessel.

21. The continuous aluminum-water reactor system of any one of claims 1 to 20, wherein at least one of the first spray nozzle, the second spray nozzle, the third spray nozzle, and the fourth spray nozzle is configured to emit a spray plume at an angle between 45-60 degrees, 60-90 degrees, or 90-102 degrees relative to a longitudinal axis of the interior cavity.

22. The continuous aluminum-water reactor system of claim 21, wherein the spray plume has a substantially cone-like shape.

23. The continuous aluminum-water reactor system of any one of claims 1 to 22, comprising a second spray nozzle at least partially disposed through the vessel wall at a position closer to the second vessel end than the first spray nozzle.

24. The continuous aluminum-water reactor system of claim 23, wherein at least one of the first spray nozzle and the second spray nozzle is configured to add water to the reactor vessel to control a water level within the interior cavity of the reactor vessel.

25. The continuous aluminum-water reactor system of claim 23, comprising a third spray nozzle at least partially disposed through the vessel wall wherein the third spray nozzle is oriented in a direction parallel to an inner surface of the vessel wall.

26. The continuous aluminum-water reactor system of claim 25, wherein the third spray nozzle is configured to emit one or more fluids in a direction and orientation such that the one or more fluids contact at least a portion of the inner surface of the vessel wall to wash and remove debris from the inner surface of the vessel wall.

27. The continuous aluminum-water reactor system of claim 25, wherein the third spray nozzle is configured to emit the one or more fluids in a direction and orientation such that the one or more fluids avoid contact with the fuel retained by a central portion of the first filter.

28. The continuous aluminum-water reactor system of claim 26 or 27, wherein the one or more fluids comprises water.

29. The continuous aluminum-water reactor system of any one of claims 1 to 28, wherein the reactor vessel is configured to operate at a pressure greater than 5 psig and/or a temperature greater than 80° C.

30. The continuous aluminum-water reactor system of claim 23, wherein the continuous aluminum-water reactor system is configured to produce at least one megawatt of thermal energy.

31. The continuous aluminum-water reactor system of any one of claims 1 to 30, wherein the one or more byproducts comprises a plurality of exfoliated fuel particles having a particle size of less than 1000 micrometers.

32. The continuous aluminum-water reactor system any one of claims 1 to 31, comprising a first inlet configured to provide the plurality of fuel particles having an initial average size, an initial maximum size, or an initial range of sizes to the interior cavity from a fuel loading apparatus.

33. The continuous aluminum-water reactor system of claim 1, comprising a second outlet comprising steam and/or hydrogen.

34. The continuous aluminum-water reactor system of any one of claims 1 to 33, comprising a sensor configured to test a concentration of the at least one byproduct at a location below the one or more filters.

35. The continuous aluminum-water reactor system of any one of claims 1 to 34, wherein the reactor vessel comprises less than 4% air and/or less than 4% oxygen.

36. The continuous aluminum-water reactor system of any one of claims 1 to 35, comprising a water recirculation line configured to exit the continuously stirred reaction vessel, catalyst recovery vessel, and/or fluid storage vessel to feed into the reactor inlet.

37. The continuous aluminum-water reactor system of any one of claims 1 to 36, comprising
a second reactor vessel comprising a second reactor filter retaining a second plurality of aluminum fuel particles;
a reactor inlet configured to provide water to the first reactor vessel and the second reactor vessel, thereby coupling the reactor vessel and the second reactor vessel in parallel;
a secondary vessel; and
a reactor outlet configured to transport byproducts from the first and second reactor vessels to the secondary vessel.

38. The continuous aluminum-water reactor system of claim 37, wherein the secondary vessel is at least one of a continuously stirred reaction vessel and a catalyst recovery vessel.

39. The continuous aluminum-water reactor system of claim 38, wherein the at least one of the continuously stirred reaction vessel and the catalyst recovery vessel further comprises an agitator and configured to mix water with at least one reactor outlet byproduct until said at least one reactor byproduct has fully reacted.

40. The continuous aluminum-water reactor system of claim 38, wherein the at least one of the continuously stirred reaction vessel and the catalyst recovery vessel comprises at least one of:
(a) a light outlet stream comprising hydrogen and steam; and
(b) a heavy outlet stream comprising water, an inert sludge, and/or a slurry.

41. The continuous aluminum-water reactor system of claim 40, wherein the light outlet stream feeds into a light stream vessel and the heavy outlet stream feeds into a heavy stream vessel.

42. The continuous aluminum-water reactor system of claim 40, wherein the light outlet stream is configured to feed into a compressor configured to increase a steam pressure, a hydrogen gas pressure, or a combination of a steam pressure and a hydrogen gas pressure to a desired outlet pressure.

43. A method for a continuous aluminum-water reaction in a reactor vessel comprising a first filter having a first mesh size disposed within a reactor vessel interior cavity configured to at least partially retain a first portion of a plurality of fuel particles having a first particles size or range of sizes, the method comprising:
spraying the first portion of the plurality of fuel particles with a fluid from a nozzle to breakdown, agitate, and/or react the fuel particles to transform the first portion of the plurality of fuel particles to byproducts capable of passing through the first filter; and
exiting one or more byproducts capable of passing through the first filter with the plurality of fuel particles to exit the reactor vessel though a first outlet, wherein the byproducts comprise at least one of activated aluminum and reacted aluminum.

44. The method of claim 43, wherein the byproducts comprise reacted aluminum, aluminum oxide, aluminum hydroxide, aluminum oxyhydroxide, or a combination of two or more thereof.

45. The method of claim 43 or 44, wherein the fluid comprises water.

46. The method of any one of claims 43 to 45, wherein the fluid consists essentially of water.

47. The method of any one of claims 43 to 46, comprising replenishing a second portion of the plurality of fuel particles having a first average size, a first maximum size or a first range of sizes into the first filter of the reactor vessel.

48. The method of any one of claims 43 to 47, wherein replenishing the second portion of the plurality of fuel particles is continuous based on a prescribed rate of inputs, based on the concentration or composition of the byproducts, or based on a prescribed time duration.

49. The method of any one of claims 43 to 47, comprising measuring a concentration of the one or more byproducts in the first outlet.

50. The method of claim 49, comprising washing an inner surface of the reactor vessel interior cavity with water emitted from a spray nozzle to remove debris.

51. The method of any one of claims 43 to 50, comprising disposing the one or more byproducts into a secondary vessel.

52. The method of claim 51, wherein the secondary vessel is at least one of a continuously stirred reaction vessel and a catalyst recovery vessel.

53. The method of claim 52, comprising reacting the one or more byproducts to completion in the secondary vessel.

54. The method of any one of claims 43 to 53, comprising mixing the one or more byproducts with water.

55. A method for a continuous aluminum-water reaction comprising:
setting up a continuous aluminum-water reactor system of any of claims 1-31, introducing the plurality of fuel particles of the first average size, the first maximum size or the first range of sizes into the first filter of the reactor vessel;
replenishing the plurality of fuel particles of the first average size, the first maximum size or the first range of sizes into the first filter of the reactor vessel;
spraying the plurality of fuel particles introduced or replenished with a fluid; and
allowing one or more byproducts of the reaction of water with the plurality of fuel particles to exit the reactor vessel though the first outlet, wherein the byproducts comprise at least one of inert aluminum and activated aluminum;
wherein replenishing the plurality of fuel particles is based on a prescribed rate of inputs, based on a concentration or a composition of the byproducts, an operating pressure within the reactor, a temperature within the reactor, or based on a prescribed time duration.

56. The method of any one of claims 43 to 54, comprising:
measuring the operating pressure within reactor vessel with a sensor;
relaying the operating pressure from the sensor to a processor;
comparing the operating pressure with a threshold pressure with the processor; and
wherein if the operating pressure is below the threshold pressure, replenishing the plurality of fuel particles into the reactor.

57. The method of any one of claims 43 to 56, comprising:
measuring the operating temperature within reactor vessel with a sensor;
relaying the operating temperature within the reactor from the sensor to a processor;
comparing the operating temperature with a threshold temperature with the processor; and
wherein if the operating temperature is below the threshold temperature, replenishing the plurality of fuel particles into the reactor.

58. The method of any one of claims 43 to 57, comprising washing an inner surface of the reactor vessel interior cavity with a fluid emitted from a spray nozzle to remove debris.

59. The method of any one of claims 43 to 58, comprising replenishing the plurality of fuel particles having the first average size, the first maximum size or the first range of sizes into the first filter of the reactor vessel.

60. The method of any one of claims 43 to 59, wherein replenishing the plurality of fuel particles occurs when the concentration of a non-fluid portion of the byproducts is greater than zero.

61. The method of any one of claims 43 to 60, wherein replenishing the plurality of fuel particles occurs when the concentration of a non-fluid portion of the byproducts is greater than 5% (w/v).

62. The method of any one of claims 43 to 61, wherein replenishing the plurality of fuel particles occurs when the concentration of a non-fluid portion of the byproducts is greater than 10% (w/v).

63. The method of any one of claims 55 to 62, comprising measuring a concentration of the one or more byproducts in the first outlet.

64. The method of any one of claims 55 to 62, comprising disposing the one or more byproducts into a secondary vessel.

65. The method of claim 64, wherein the secondary vessel is at least one of a continuously stirred reaction vessel and a catalyst recovery vessel.

66. The method of claim 65, comprising reacting the one or more byproducts to completion in the secondary vessel.

67. The method of any one of claims 55 to 66, comprising mixing the one or more byproducts with water.

68. The method of any one of claims 55 to 67, wherein replenishing the plurality of fuel particles occurs when the prescribed time duration is greater than one minute.

69. The method of any one of claims 55 to 68, wherein replenishing the plurality of fuel particles occurs when the prescribed time duration is greater than five minutes.

70. The method of any one of claims 55 to 68, wherein replenishing the plurality of fuel particles occurs when the prescribed time duration is greater than one hour.

71. The method of any one of claims 55 to 68, wherein replenishing the plurality of fuel particles occurs when the prescribed time duration is greater than 24 hours.

72. The method of any one of claims 55 to 68, wherein spraying the plurality of fuel particles comprises emitting a spray plume the fluid from a first spray nozzle, a second spray nozzle, a third spray nozzle, a fourth nozzle, and/or any combination of two or more thereof.

73. The method of any one of claims 55 to 72, wherein at least one of the first spray nozzle, the second spray nozzle, the third spray nozzle, and the fourth spray nozzle is configured to emit a spray plume at an angle between 45-60 degrees, 60-90 degrees, or 90-120 degrees relative to a longitudinal axis of the reactor vessel.

74. The method of claim 72 or 73, wherein the spray plume has a substantially cone-like shape.
